(19) United States
(12) Patent Application Publication
(10) Pub. No.: US 2026/0095243 A1
(43) Pub. Date: Apr. 2, 2026

(54) EDGE COMPUTING AND METASURFACES IN NON-TERRESTRIAL NETWORK-CONNECTED TRANSCODER NODES

(71) Applicant: Dell Products L.P., Round Rock, TX (US)

(72) Inventors: Tejinder Singh, Manotick (CA); Navjot Kaur Khaira, Manotick (CA); Michael J. Healy, Scituate, MA (US)

(21) Appl. No.: 18/902,158

(22) Filed: Sep. 30, 2024

(51) Int. Cl. H04B 7/185

(52) U.S. Cl. CPC H04B 7/18513

(57) ABSTRACT

The technology described herein is directed towards a transcoder with bypass capabilities that can be used to couple non-terrestrial network satellites to user equipment (UEs), including by decoding and reencoding data packets at the packet level for existing Satcom satellites. An edge computing device with trained artificial intelligence models in transcoder nodes optimize bandwidth usage, reduce latency, and enhance the performance of real-time applications, whereby a transcoder device can handle data preprocessing, anomaly detection, predictive analytics, and real-time optimization, reducing the need for satellite bandwidth. A metasurface (reconfigurable intelligent surface, or RIS) redirects signals from the satellite to a satellite radio frequency (RF) interface of the transcoder, with the transcoder also coupled by a UE RF interface to a UE, such as a computing device or cellphone. For a Satcom satellite, the transcoder converts, at the packet level, satellite-originating signals to UE-compliant signals, and converts UE-originating signals to Satcom-compliant signals.

### RELATED APPLICATION

The subject patent application is related to U.S. patent application Ser. No. 18/780,254, filed Jul. 22, 2024, and entitled “TRANSCODING THE AIR-INTERFACE BETWEEN NON-TERRESTRIAL AND TERRESTRIAL NETWORKS LEVERAGING INTEGRATED METASURFACES” (docket no. 139018.01/DELLP1230US), the entirety of which patent application is hereby incorporated by reference herein.

### BACKGROUND

Non-terrestrial network communications are defined as part of fifth generation (5G) communications in current third generation partnership project (3GPP) standards. However, the reliability of non-terrestrial network satellite direct-to-device service is problematic, especially when a user equipment (UE) moves to an indoor environment, due to various radio frequency signal attenuations introduced by a roof, wall, or other physical structures that are between a satellite and the UE. As such, present satellite communication (non-terrestrial network) services basically require a line-of-sight (LoS) path between a satellite and a user equipment device to reduce radio frequency signal fading or shadowing in order to provide reliable communication. Further, the air-interfaces of satellite communications (Satcom, sometimes “SatCom” and other times “SATCOM”) and those used for terrestrial mobile wireless (5G, LTE and the like) have significant differences, including having to comply with different standards from one another.

### BRIEF DESCRIPTION OF THE DRAWINGS

The technology described herein is illustrated by way of example and not limited in the accompanying figures in which like reference numerals indicate similar elements and in which:

FIG. 1 is a representation of multiple example locations for deploying a metasurface (reconfigurable intelligent surface, or RIS) indoors, including metasurfaces configured to operate in a transmission mode and reflection mode, in accordance with various example embodiments and implementations of the subject disclosure.

FIG. 2A is a representation of example uplink (UL) and downlink (DL) communication paths between a user equipment to a satellite via a layer-1 physical conversion (L1-PHY) transcoder and RIS Component, in which the RIS component is independent L1-PHY transcoder, in accordance with various example embodiments and implementations of the subject disclosure.

FIGS. 2B and 2C are representations of example metasurfaces configured to operate in a transmission mode and reflection mode, respectively, in accordance with various example embodiments and implementations of the subject disclosure.

FIG. 3 is a block diagram showing an example hardware-based transcoder device in which radio frequency (RF) downlink and uplink signals are connected for RF input and output, in accordance with various example embodiments and implementations of the subject disclosure.

FIG. 4 is a block diagram showing an example L1-PHY module/component of a transcoder device, with bypass capability, and with an edge compute device, in accordance with various example embodiments and implementations of the subject disclosure.

FIG. 5 is an example system architecture sequence diagram, in accordance with various example embodiments and implementations of the subject disclosure.

FIG. 6 is an example data processing workflow, in accordance with various example embodiments and implementations of the subject disclosure.

FIG. 7 is an example resource management sequence diagram, in accordance with various example embodiments and implementations of the subject disclosure.

FIG. 8 is an example bandwidth optimization process, in accordance with various example embodiments and implementations of the subject disclosure.

FIG. 9 is an example event flow diagram for the integration of AI optimization models, in accordance with various example embodiments and implementations of the subject disclosure.

FIGS. 10 and 11 comprise a flow diagram representing example remote management and monitoring operations related to the integration of artificial intelligence optimization models, in accordance with various example embodiments and implementations of the subject disclosure.

FIG. 12 is an example top view representation of an example metasurface panel that can be configured to operate in a transmission mode or a reflection mode, in accordance with various example embodiments and implementations of the subject disclosure.

FIG. 13 is an example top view representation of an example unit-cell suitable for use in a metasurface that operates in a transmission mode or a reflection mode, in accordance with various example embodiments and implementations of the subject disclosure.

FIG. 14 is a representation of an example system-level end-to-end network showing how a data packet is communicated from an indoor notebook, via a metasurface, to and from a space mesh network, in accordance with various example embodiments and implementations of the subject disclosure.

FIG. 15 is a flow diagram showing example operations related to uplink communications of edge compute device-preprocessed uplink data based on a trained model that selects between converting a terrestrial uplink communication signal to a non-terrestrial uplink communication signal or bypassing the conversion, in accordance with various example embodiments and implementations of the subject disclosure.

### DETAILED DESCRIPTION

The technology described herein is generally directed towards connecting user equipment type modems (e.g., 3GPP-compliant 4G/5G commercial off the shelf devices and beyond) to the legacy satellite satcom communication protocol, whereby user equipment (UE) are able to communicate with satellite services. Significantly, via a Layer-1 physical (L1-PHY) transcoder, the technology described herein provides the capability for the UE to communicate with a low earth orbit (LEO) satellite or a terrestrial tower using two different air-interfaces. The two air-interfaces include the DVB-compliant Satcom interface and 3GPP-compliant fifth generation new radio (5G NR) Direct-to-Device (D2D) interface. This dual RF capability allows the L1-PHY transcoder to operate at two different frequency bands, legacy satcom and the newer 3GPP FR1/FR2 bands.

The technology described herein integrates edge computing capabilities and trained artificial intelligence (AI) models into transcoder nodes to optimize bandwidth usage, reduce latency, and enhance the performance of real-time applications. By deploying high-performance embedded systems and machine learning models, a transcoder device/system can handle data preprocessing, anomaly detection, predictive analytics, and real-time optimization locally, reducing the need for extensive satellite bandwidth. One example implementation is designed to be scalable, with remote management and monitoring capabilities, ensuring efficient operation and adaptability as a network of such edge devices expands.

The L1-PHY transcoder uses device multiplexing (e.g., silicon Muxing) to switch between air interfaces, as determined by a controller. The controller can be artificial intelligence/software based, and can thus switch the multiplexer states and corresponding bypass or transcoder conversion modes as needed for various communication scenarios as described herein. Thus, for example, via the technology described herein, UEs such as notebook computers and cellphones can connect directly to satellites with no modification to any legacy satellite or to the UE. This is significant because many satellites were put into orbit many years ago, whereby changing their native air-interface is impractical, and at the same time modifying and adding features to a 3GPP-compliant modem takes on the order of years to design, test, implement and deploy.

As will be understood, a multiplexer (Mux) can shift to a bypass mode, enabling the UE to use its native 5G NR air interface directly. This bypass operation mode allows the system to bypass/(depopulate) the expensive encode/decode and RF front-end modules, significantly reducing costs while maintaining robust connectivity. The dual RF front-end integration that combines RF front-ends for both 5G NR and Satcom, e.g., within a single transcoder device (“box” structure), allows seamless interoperation between terrestrial and non-terrestrial, enabling devices that typically operate on different frequency bands to communicate without requiring substantial modifications. Thus, the L1-PHY transcoder supports both Satcom and direct-to-device (D2D) 5G NR air interface, thus converting an otherwise standard 5G NR modem into a true Satcom modem, with the ability to switch between D2D 5G NR and Satcom air interfaces (satellite-side). This flexibility allows UEs to seamlessly communicate using either interface.

Further, the integration of a metasurface, or reconfigurable intelligent surface (RIS integration) facilitates portability and disaggregation. More particularly, while the indoor radio frequency (RF) signal is converted using the transcoding technology described herein, the indoor RF signal needs to get outdoors to achieve line-of-sight (LoS) connectivity directly to the satellite. RIS technology provides the capability to transmit the indoor RF signal to the outdoor environment, that is, transmit the UE signal from indoors-to-outdoors and outdoors-to-indoors wirelessly, eliminating the need for a physical cable to connect a mounted outdoor antenna to indoor UEs. Among other benefits, a RIS also adds the benefit of portability, and different ways to deploy the transcoder device. For example, the transcoder device can be standalone box, integrated into an antenna, tether-box attached to notebook, and so on. The transcoder device and RIS also can be disaggregated, e.g., to have some components/features in a computing device such as a notebook, and other components/features in an external RIS/antenna.

It should be understood that any of the examples and/or descriptions herein are non-limiting. Thus, any of the embodiments, example embodiments, concepts, structures, functionalities or examples described herein are non-limiting, and the technology may be used in various ways that provide benefits and advantages in communications and metasurfaces in general.

Reference throughout this specification to “one embodiment,” “an embodiment,” “one implementation,” “an implementation,” etc. means that a particular feature, structure, characteristic and/or attribute described in connection with the embodiment/implementation can be included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, characteristics and/or attributes may be combined in any suitable manner in one or more embodiments/implementations. Repetitive description of like elements employed in respective embodiments may be omitted for sake of brevity.

The detailed description is merely illustrative and is not intended to limit embodiments and/or application or uses of embodiments. Furthermore, there is no intention to be bound by any expressed or implied information presented in the preceding sections, or in the Detailed Description section. Further, it is to be understood that the present disclosure will be described in terms of a given illustrative architecture; however, other architectures, structures, materials and process features, and steps can be varied within the scope of the present disclosure.

It also should be noted that terms used herein, such as “optimize,” “optimization,” “optimal,” “optimally” and the like only represent objectives to move towards a more optimal state, rather than necessarily obtaining ideal results. Similarly, “maximize” means moving towards a maximal state (e.g., up to some processing capacity limit), not necessarily achieving such a state, and so on.

It will also be understood that when an element such as a layer, region or substrate is referred to as being “on” or “over” “atop” “above” “beneath” “below” and so forth with respect to another element, it can be directly on the other element or intervening elements can also be present. In contrast, only if and when an element is referred to as being “directly on” or “directly over” another element, are there no intervening element(s) present. Note that orientation is generally relative; e.g., “on” or “over” can be flipped, and if so, can be considered unchanged, even if technically appearing to be under or below/beneath when represented in a flipped orientation. It will also be understood that when an element is referred to as being “connected” or “coupled” to another element, it can be directly connected or coupled to the other element or intervening elements can be present. In contrast, only if and when an element is referred to as being “directly connected” or “directly coupled” to another element, are there no intervening element(s) present.

The following detailed description is merely illustrative and is not intended to limit embodiments and/or application or uses of embodiments. Furthermore, there is no intention to be bound by any expressed or implied information presented in the preceding sections, or in the Detailed Description section.

One or more example embodiments are now described with reference to the drawings, in which example components, graphs and/or operations are shown, and in which like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details, and that the subject disclosure may be embodied in many different forms and should not be construed as limited to the examples set forth herein.

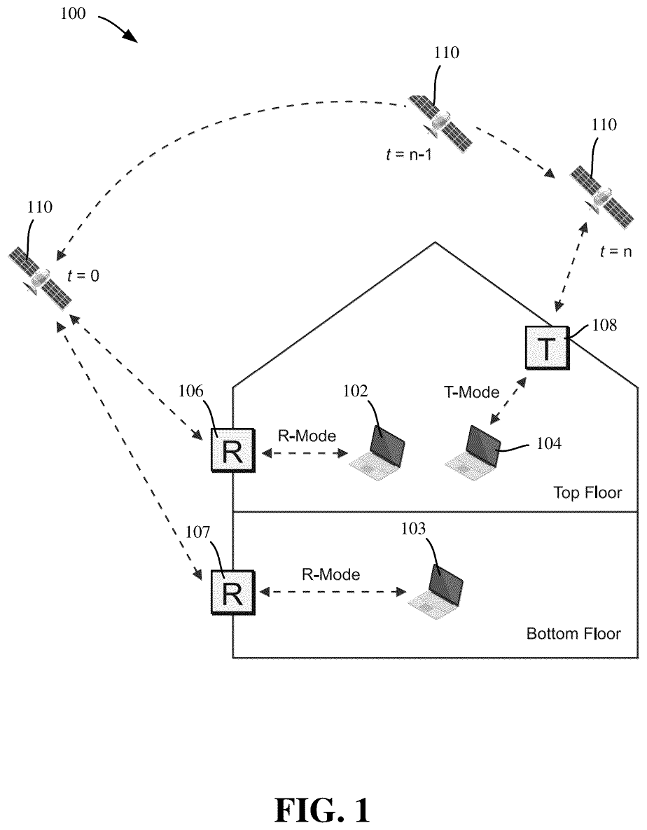

FIG. 1 is a representation of an example environment 100 including user equipment 102-104 operating indoors, and metasurfaces 106-108. As described herein, the metasurfaces 106-108 are used to offer signal boost in the 3GPP standardized non-terrestrial network frequency bands.

In general, a metasurface (sometimes referred to as a reconfigurable intelligent surface, or RIS) of unit cells is deployed between a satellite and a user equipment (UE). The metasurface can be configured to act as a passive signal gain booster to provide a reliably connected non-terrestrial network service, including in indoor UE scenarios. There is significant signal attenuation experienced by non-terrestrial network services with respect to penetrating indoor environments. Such variability in attenuation, influenced by construction materials and their moisture content, impedes the reliability and performance of direct-to-device connections. This attenuation can range from minimal to severe, ranging from 3 dB (50%) to virtually complete attenuation; for example, metal roofing and attics equipped with radiant barriers present the most challenging conditions, exhibiting signal losses up to 30 dB (99.9% reduction).

To counteract such signal attenuation challenges, the integration of metasurface technology as described herein facilitates non-terrestrial network direct-to-everything service reliability, by using a (for example portable) designed metasurface to boost the attenuated RF signals to and from a satellite, to ensure an end-to-end link supporting always-on connectivity. In general, metasurfaces are surfaces engineered to manipulate electromagnetic waves, offering a pathway to enhance signal strength in either reflection or transmission modes. A metasurface such as described herein can be designed in a way that reduces the fabrication costs exponentially relative to other technologies, as in general a metasurface only needs a single layer of metallization on a substrate. The metasurface can be used for direct-to-everything (DTX) communications, including with smartphones, laptops, automotive vehicles, IoT devices, or inter-device communication, as long as the operating RF frequency is within the gain band of specially designed metasurface.

One implementation of the technology described herein includes a passive (no power needed) metasurface that can be reconfigured into reflection mode or transmission mode by simply attaching or removing a metallic backplane to or from the metasurface. More particularly, a passive metasurface signal booster does not require power to function, and the reconfiguration to the reflection mode can be achieved by attaching a metallic back plane panel to the underside of the metasurface, or removing the back plane to achieve transmission mode. These designs add additional benefits to ensure non-terrestrial network connectivity even during a power outage, which is significant for the safety and emergency response community.

In one implementation, the metasurface can be sufficiently small in size so as to be portable, which can be carried when traveling or moved within a building as needed to enhance the signal strength with respect to non-terrestrial network uplink and downlink communications. The portability of the metasurface allows a user to test out multiple candidate positions, using either a transmission mode or a reflection mode of the metasurface within the targeted indoor environment. In this way, the user knows ahead of time that the non-terrestrial network service is not limited to a single spot. This significantly increases the convenience for the user; for example, in a scenario where the roofing material of a target building only has a few dB of attenuation at non-terrestrial network service link frequency, the metasurface booster gain operating in the transmission mode is adequate to compensate for that small loss. This removes the line-of-sight requirement between the user equipment and the satellite field of view. In general, a user can sit anywhere in a room with boosted non-terrestrial network signal through the transmission mode of a suitably placed portable metasurface, which further enhance the flexibility of the non-terrestrial network service.

In general, a satellite is always in the (low attenuation) field-of-view of a metasurface with respect to the non-terrestrial network (NTN) frequency bands; before one NTN communications satellite travels out of the field of view, another one moves in. Although only a single satellite 110 is depicted in FIG. 1 (at different times t=0, t=n−1 and t=n), it is understood that at least one satellite is typically always within the field of view of any of the metasurfaces 106-108.

In FIG. 1, the two reflecting mode (“R”) metasurfaces 106 and 107 and one transmission mode (“T”) metasurface 108 provide satellite communication signals to and from user equipment, e.g., laptop or notebook computers 102-104. Note that instead of multiple UE computers 102-104, a single computer can be moved among the various coverage locations of the metasurfaces 106-108.

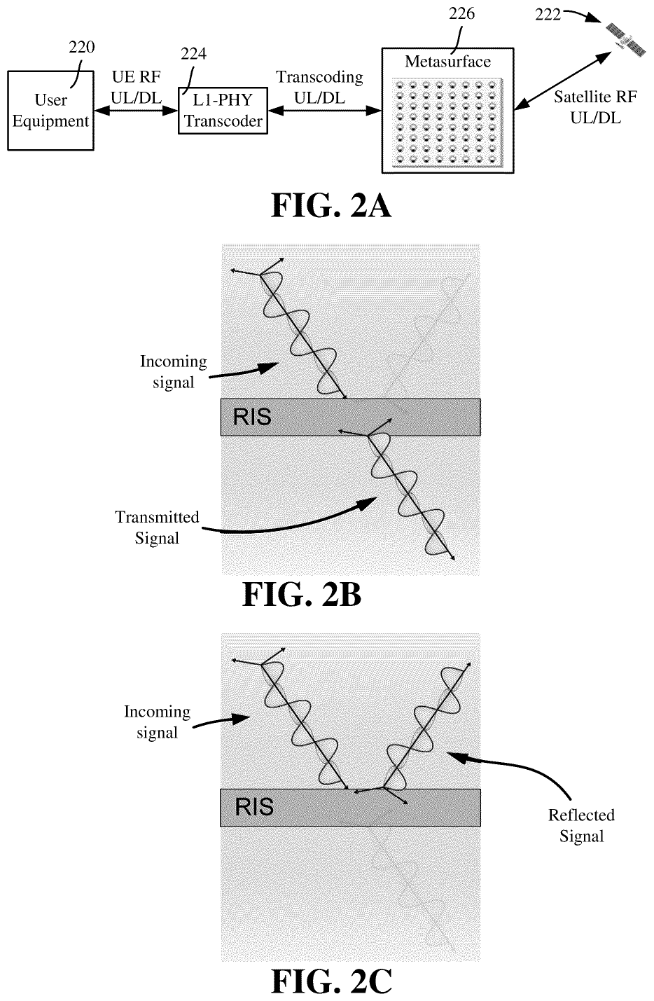

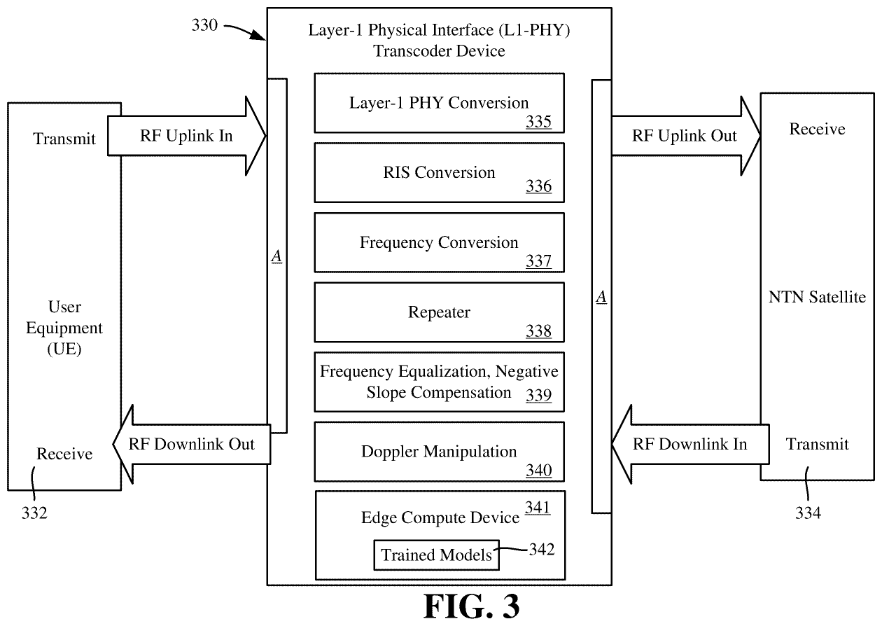

FIG. 2A shows one possible physical form factor for a system/architecture in which a user equipment 220 communicates (in uplink/UL and downlink DL directions) with a satellite 222, via an L1-PHY transcoder node/device 224 and a metasurface 226; the interfaces are radio frequency (RF) interfaces. In this example, the metasurface is separated into a RIS component that is independent of the L1-PHY transcoder node/device 224; notwithstanding, alternate form factor implementation can have the metasurface 226 integrated into the L1-PHY transcoder node/device 224. As described herein, an edge compute device is included in the L1-PHY transcoder node 224.

The technology described herein is generally directed to a system that combines edge computing device with one or more AI models to perform data processing tasks locally. This reduces the dependency on satellite communication, optimizing bandwidth usage and enhancing data transmission efficiency. Integrating such AI models facilitates intelligent data processing, including anomaly detection and dynamic optimization of data transmission.

One implementation of the system incorporates a resource manager and thermal manager to dynamically allocate computational resources based on real-time needs. By prioritizing certain tasks and managing thermal overhead, the system ensures more optimal performance and longevity of the edge devices. Further, utilizing management/metric capturing platforms, the system provides robust remote management capabilities such as including, but not limited to, real-time performance monitoring, software updates, and configuration changes, enabling scalable and efficient management of a growing network of edge nodes. By processing and filtering data locally, only the appropriate (e.g., deemed essential/critical) information is sent to the satellite. Filtering helps in prioritizing the transmitted data, reducing the amount of data transmitted, optimizing bandwidth usage and lowering costs associated with satellite communication.

By leveraging metasurface technology, multiple edge-enabled transcoder boxes can communicate with each other, creating a mesh network that enhances overall system performance and reliability. The system can grow with increasing data and application demands by integrating additional edge nodes as needed.

FIGS. 2B and 2C illustrate how an electromagnetic (EM) wave can be redirected by a reflective intelligent surface (RIS), through transmission or reflection, that is, FIGS. 2B and 2C show the concept of a metasurface (reconfigurable intelligent surface, or RIS) in transmission and reflection modes, respectively. As can be seen, in the transmission mode of FIG. 2B, the RIS is basically transparent to the incoming signal, and as described herein (and not explicitly shown in FIG. 2B), respective unit cells of the RIS can be designed with different phase shifts so as to passively refract respective portions of the incoming signals and thereby boost the incoming signal via constructive interference (gain array) of the different refracted respective portions of the incoming waves as refracted by the respective unit cells. Similarly, in the reflection mode of FIG. 2C, the RIS basically reflects a very large percentage of the incoming signal, and as described herein, the respective unit cells of the RIS can be designed with different respective phase shifts so as to passively reflect respective portions and boost via gain array the incoming signal via constructive interference of the different reflected respective portions of the incoming waves as reflected by the respective unit cells.

As set forth herein, the range of signal attenuation (e.g., in dB/inch) is different for various commonly used building materials such as plywood, clear glass, cinder block, drywall, and ceiling tile; each material's attenuation properties change with frequency. These building materials have lower attenuation (non-negligible) at lower frequencies, however as expected, the attenuation increases as the frequency rises, which indicates that higher frequencies face greater attenuation, which is a challenge for direct-to-device services that operate at these frequencies. However, the metasurfaces 106-108 in FIG. 1 are positioned to mitigate the attenuation issue, e.g., the two reflecting mode (“R”) metasurfaces 102 and 103 can be placed by windows or behind other low-attenuation materials, while the transmitting mode metasurface 104 can be placed near the ceiling or in line with a skylight so as to have a reasonable line-of-sight connection (i.e., low attenuation conditions) with any position of any satellite in each metasurface's field of view.

Turning to satellites in general, satellite communications (satcom) have long been commercialized to provide mobile (aviation, sea, railroad), fixed (isolated rural area), and broadcast services for decades, while the terrestrial network has gone through 2G, 3G, 4G and 5G evolutions. With 3GPP now adding non-terrestrial networks (NTN) in the standards definition of 5G, satellite direct-to-device is likely to be used with smartphones, sensors, laptops and connected vehicles, wherever stable connectivity can be assured between such user equipment and a satellite. Indeed, 3GPP NR-non-terrestrial network standards enable non-terrestrial network direct-to-everything services, by defining a high-level architecture that is compatible with most mobile handsets and internet-of-things (IoT) devices, as well as defining the operating bands in FR1 for UE to transmit and receive data with a satellite. The following table 1 shows the satellite operating bands in FR1 as defined by 3GPP Release 17:

TABLE 1

| | Uplink (UL) operating | Downlink (DL) | |
|---|---|---|---|
| Satellite | band SAN receive/ | operating band SAN | |
| operating | UE transmit | transmit/UE receive | Duplex |
| band | F_{UL, low}-F_{UL, high} | F_{DL, low}-F_{DL, high} | mode |
| n255 | 1626.5 MHz-1660.5 MHz | 1525 MHz-1559 MHz | FDD |
| n256 | 1980 MHz-2010 MHz | 2170 MHz-2200 MHz | FDD |

Note that 3GPP is currently considering new radio (NR)-non-terrestrial networks above 10 GHz in the FR2 band. The Ka-band is the highest-priority band with uplinks between 17.7 and 20.2 GHz and downlinks between 27.5 and 30 GHz, based on ITU (International Telecommunication Union) information regarding satellite communications frequency use. It is expected that FR2 band will be standardized in the future 3GPP releases.

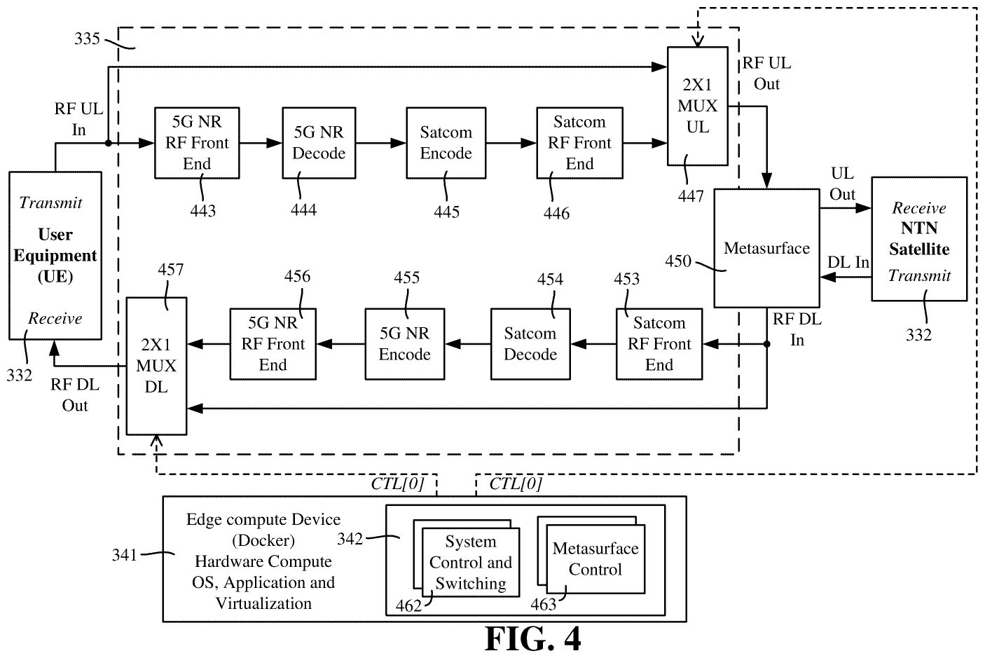

In one or more example implementations, as shown in FIG. 3, described herein is a transcoder device 330 (e.g., in the structure of a “box”) that couples a user equipment 332 to a non-terrestrial network (NTN) satellite 334 with respect to RF uplink signals from the user equipment 332 to the satellite 334, and RF downlink signals from the satellite 334 to the user equipment 332. Various types of user equipment can include, but are not limited to, personal (e.g., notebook/laptop) computers, other computing devices, cellphones, wireless-tether-boxes, fixed wireless access (FWA)-boxes, and IoT/NB-IoT (internet of things/narrowband-internet of things) devices.

As shown in FIG. 3, a number of hardware and/or software-based modules/components 335-341 perform various functions related to the transcoding of RF input to RF output, in both uplink and downlink directions, according to the input protocols, formatting, and so forth, in the appropriate output format for the receiving entity. Note that such transcoding is not needed for the new radio non-terrestrial networks, e.g., using FR1 and FR2 bands as described herein. While these modules as described herein are shown separated in one example implementation, this is only one non-limiting example, and the various functionality performed thereby can be divided among more modules, and/or at least some of the example modules can be combined together to perform the transcoding-related functionality as described herein.

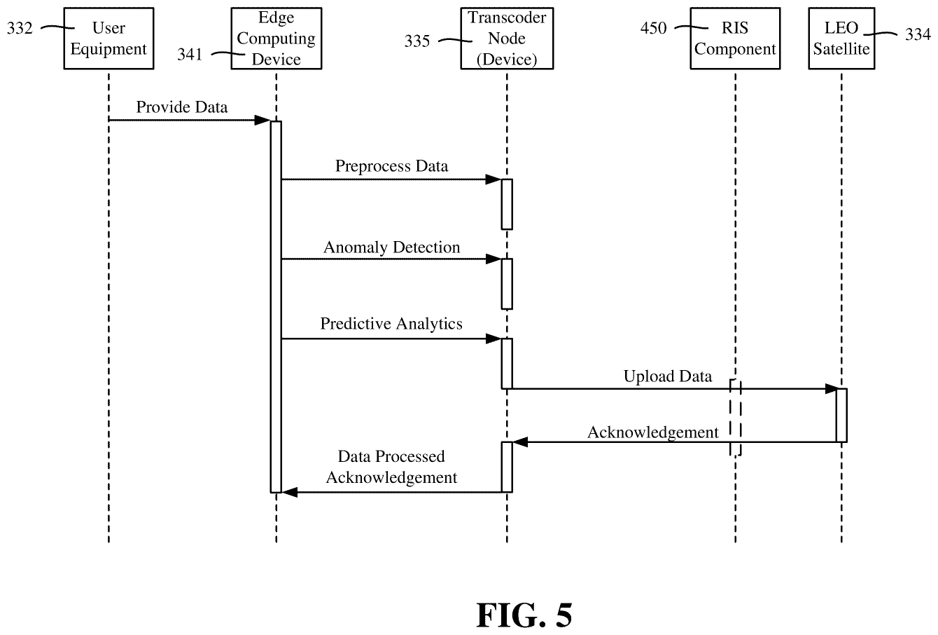

In the example of FIG. 3, when transcoding (5G to or from Satcom) is appropriate, a layer-1 physical interface (L1-PHY) transcoder conversion device 335, with bypass capability, performs L1-PHY gate-level packet-level conversion. As shown in more detail in FIG. 4, L1-PHY gate-level packet-level conversion is performed in the UE uplink direction, from the RF front-end control interface (RFFE) 443/(e.g., 5G NR) decode (block 444), to the packet-level satcom encoded (block 445)/RFFE 446 satellite uplink. In the satellite downlink direction, the L1-PHY transcoder conversion module 335 performs packet-level satcom-to-RFFE 453 decode operations (block 454) to 5G NR encoded (block 456)/RFFE 457 user equipment downlink packets. As shown in FIG. 3, one or more antennas A couple the transcoder device 330 to the user equipment 332 and the NTN satellite 334, which may be via a metasurface (also referred to as a reconfigurable intelligent surface, or RIS 450) as described herein.

More particularly, in the uplink direction from the UE, the L1-PHY conversion module 335 of the transcoder device 330 decodes (block 442) the 5G NR terrestrial air-interface down to the native digital packet-level. Then the L1-PHY conversion module 335 reencodes (block 443) the packets into the legacy satcom air-interface protocol. The downlink direction is the inverse, that is, the L1-PHY conversion module 335 decodes (block 446) the satcom protocol to the packet-level, then reencodes (block 447) to the 5G NR air-interface protocol.

An uplink bypass path is also available for D2D 5G NR, e.g., as represented by the uplink input signal being coupled to one input of an uplink multiplexer (UL Mux) 447. Note that although not explicitly shown in FIG. 4, an optional frequency converter in the uplink bypass path may be present and invoked for situations where the user equipment does not support the 5G NR satellite frequency band(s).

Thus, as described herein, the dual-band device includes an uplink multiplexer (UL Mux) 457 that facilitates selecting between which path to take to transmit to the NTN satellite 334, namely the transcoder/conversion state for Satcom, or the D2D state 5G NR. A control signal CTL[0] determines which state is selected, e.g., as determined by a trained system control and switching model controller as described herein, which in one or more example implementations is a trained artificial intelligence (AI) model.

In one implementation, the uplink multiplexer 457 is a 2×1 Mux that selects between the uplink “Satcom” pipeline path or the “D2D 5G NR” path. The uplink multiplexer 457 can be a dumb hardware Mux, physically selecting the uplink path, e.g., with no dynamically switching Mux features on its own.

FIG. 4 also shows that the output of the 2×1 UL Mux 457 feeds the RIS component 450. The RIS component 450 may be programmed or otherwise configured to operate with multiple frequencies from the Mux output.

With respect to 5G decoding and reencoding in the transcoder conversion pipeline path, note that the 3GPP-compliant 5G NR Layer-1 physical interface logic block diagram is published. The following summarizes some features of 5G NR direct-to-device (D2D) operations and concepts with respect to NTN satellites:

NTN Mode = 3GPP Transparent-Mode
L1-Physical Interface = 3GPP-compliant Layer-1 PHY logic blocks
Bands = mobile network operator (MNO) terrestrial frequency bands
Service-Link = direct-to-device mode (mobile wireless) air-interface
Feeder-Link = repeated, amplified, frequency-converted to NTN Gateway
frequency-band air interface
Antenna Technology = varies, depends on FR1/FR2/NTN bands
Physical Constraints = mobile wireless operation, physical challenges
Interference, Weather, Scintillation, Channel Modeling, Link-Budget
Analysis = mobile wireless operation, various challenges
Use-Case/Market/Protocol = IoT, NB-IOT, RedCap, 5G NR
Packet-Format/Tunneled-Packet = 3GPP GTP-Tunnel, IP, UDP, etc.

For the air interface, note that satcom (Digital Video Broadcasting (DVB)-Compliant L1-PHY details are published, including a logic block diagram of a DVB-compliant DVB-S2 Layer-1 Physical Interface (L1-PHY). The logic blocks used on the L1-PHY portion of the satcom can be specific to the DVB-standardized satcom protocol; the DVB standards are global standards that have defined the satcom protocol for many years, and many deployed legacy satellites support the early DVB-S standards. Over the years the DVB consortium has moved from the original DVB-S to DVB-S2 to DVB-S2 to the latest DVB-S2X. The following summarizes some features of satcom operation:

NTN Mode = satcom, legacy DVB standards
L1-Physical Interface = satcom DVB protocol L1-PHY logic blocks
Bands = satcom satellite frequency bands, K, Ku, Ka, Q/V, S, L
Service-Link = satcom air-interface
Feeder-Link = satcom air-interface
Antenna Technology = varied, depends on K, Ku, Ka, Q/V, S, L bands
Physical Constraints = mobile and static wireless operation, physical
challenges
Interference, Weather, Scintillation, Channel Modeling, Link-Budget =
mobile and static wireless operation, various challenges
Use-Case/Market/Protocol = satcom L1-PHY, satellite broadband
providers, military, governments
Packet-Format/Tunneled-Packet = satcom, varied packet formats
through the years.

A comparison of 5G NR and satcom air-interfaces is shown in the Table 2 below summarizing the above features used by the 3GPP terrestrial mobile wireless industry and the satcom satellite industry. The frequency bands are different from one another, and the frequencies are approved through two different standards organizations, 3GPP and DVB. Some satcom bands have been used for satellite communication for over twenty years, while 3GPP 5G NR bands were allocated around approximately 2015.

TABLE 2

| | satcom | 3GPP 5G NR D2D |
|---|---|---|
| L1-PHY | DVB-S/S2/S2X | 3GPP 5G NR L1 PHY |
| Air Interface | satcom DVB-S/S2/S2X | 3GPP Rel19 5G NR |
| Freq Bands | Bands K, Ku, Ka, Q, V, | FR1/FR2/NTN MNO bands |
| | S, L (WRC allocated) | approved by 3GPP and |
| | | WRC |
| Market | Mobile wireless, VSAT | Direct-to-Device (D2D), |
| | Broadband, fixed- | UE talks directly to |
| | satellite serves (FSS), | satellite, IoT/NB-IOT, |
| | IoT/NB-IOT | RedCap, FWA Broadband |
| Use Case | Broadband, disaster- | Personal cell, notebook, |
| | relief, emergency comms, | any UE |
| Users | VSAT, govt, military, | Mobile wireless |
| | broadband customers, | subscribers/Mobile |
| | | Network Operator (MNO) |
| Satellite Era | Legacy and new satellites | NA |
| (legacy/new) | | |
| Constellations | STARLINK, KUIPER, | NA (limited support for |
| | ONEWEB, DISH/ | 3GPP transparent-mode, |
| | HUGHES/ECHOSTAR, | no support for |
| | SDA, GLOBALSTAR, | regenerative-mode) |
| | IRIDIUM, AST, ATT, | |
| | TELESAT, etc. | |
| Terrestrial | NA | 5G NR |
| Network | | |

As described herein, the transcoder device 330 can be integrated with reconfigurable intelligent surface (RIS) technology to relay the satellite downlink signal into the indoor environment, and vice-versa to relay the indoor UE signal-to-satellite uplink. This removes the constraints of line-of-sight (LoS) between the UE and satellite.

Returning to FIG. 3, metasurface or RIS conversion, represented by block 336, is included for both the UE-side and the satellite-side. A metasurface, or RIS can be used to convert the downlink signal received from the satellite 334 for redirection to the UE 332 by including a frequency converter in between and boosting the signal amplitude, which can be, at least in part, by passive array gain. The metasurface can be similarly used with the uplink signal received from the UE 332 for redirection to the satellite 334. This conversion is not limited to amplitude, but can also include phase change, signal leveling, distortion compensation, up conversion, down conversion, and/or the like, by integrating radio frequency integrated circuit (RFIC) circuitry with the RIS conversion 336 functionality.

With respect to satellite and user equipment frequencies, terrestrial and non-terrestrial networks use different frequency bands, without any sharing therebetween, resulting in issues in the merging of terrestrial and non-terrestrial networks when it comes to frequency bands and air-interfaces. One challenge is that, when using mobile network operator frequency bands or satellite (satcom) frequency bands, there are significant band-rights regulation issues.

The following table 3 shows some satcom and terrestrial frequency bands:

TABLE 3

| | Service-Link | |
|---|---|---|
| Frequency Bands | Uplink | Downlink |
| Terrestrial (5G NR) Bands | FR1 (Sub-6 GHz) | FR1 (Sub-6 GHz) |
| Mobile Network Operator (MNO) | FR2 (mmWave) | FR2 (mmWave) |
| Satcom Bands | L-Band | L-Band |
| | S-Band | S-Band |
| | Ku-Band | Ku-Band |
| | K-Band | K-Band |
| | Ka-Band | Ka-Band |
| | Q/V -Bands | Q/V -Bands |

Frequency conversion is thus needed for the transcoding, and as described herein block 337 represents converting between the 3GPP air-interface and the satcom air-interface frequencies. As is understood, this includes mobile network operators (e.g., 5G)-to-satcom frequency (band) conversion, and satcom-to-mobile network operator frequency (band) conversion. In general, frequency conversion at satellite frequencies is well understood and not described in detail herein, except to reiterate that the frequency conversion of block 337 includes satcom-to-5G and 5G-to-satcom frequency conversion.

A repeater (block 338) can perform other functions, such as including, but not limited to, re-clocking, amplification, and power level adjustment, and can be based on a generic transponder/frequency converter, where in general, a transponder is a broadband RF channel used to amplify one or more carriers on the downlink side of a geostationary communications satellite. A transponder is simply a repeater that takes in the signal from the uplink at one frequency, amplifies the signal and sends it back on another frequency. Satellites can have bent-pipe repeaters, which receive signals in the uplink beam, block translates them to the downlink band, and separates them into individual transponders of a fixed bandwidth. A transponder can be amplified by a traveling wave tube amplifier (TWTA) or a solid state power amplifier (SSPA).

Frequency equalization and negative-slope compensation are incorporated into block 339 of FIG. 3. One of the features of the transcoder device 330 is to equalize the frequency and create a negative image of the loss generated from the conversion, and superimpose it into an equalizer to maintain constant loss over the band. A negative slope compensation technique can be a purely passive resistor network-based technique that can be implemented in the RF chain; the equalization can be hardware-based, software-based, or a combination of both.

Another module/component shown in FIG. 3 is directed towards three-dimensional (3D) doppler shifting/correction/compensation, wherein the Doppler effect (also known as Doppler shift) is the change in the frequency of a wave from the perspective of an observer when the source of the wave and the observer are moving relative to one other. Doppler manipulation (block 340) compensates for the movement as the satellite flies overhead. To this end, the doppler manipulation 340 adjusts based on tracking the changing x-y-z dimensions of the satellite (and the observer RIS, if moving, such as in a vehicle or drone). In this way, for example, the L1-PHY transcoder device 330 can deliver hardware-based doppler-modification data to allow commercially available 5G NR modems (UEs) to communicate better with satcom satellites without any UE modifications.

To summarize, FIGS. 3 and 4 are directed to 5G NR-enabled device uplink transmission, from left-to-right, and satellite downlink transmission, from right to left. The 5G NR-enabled device 332 (e.g., a notebook or smartphone) transmits an RF uplink signal, e.g., using a commercially available 5G NR-enabled components and antenna, e.g., integrated into the device. The RF uplink signal is fed into the L1-PHY transcoder box 335 for processing, and in this particular example, to the 5G NR RF front end component 443, or sent to the Mux 447 via the bypass path.

For Satcom conversion, the 5G NR RF front end component 441 thus receives the RF uplink signal from the user equipment 332 and processes the signal. The front-end handling can include initial filtering, amplification, and/or frequency conversion used for further processing. For decoding to the packet level, the processed RF signal is decoded down to the packet level using 5G NR logic blocks. This can include equalization, demodulation and/or forward-error-correction decoding to extract the data packets from the RF signal. Packet-level transcoding operates via packet conversion, in which the decoded 5G NR packets are converted to Satcom packets. This ensures that the data can be accurately and efficiently transmitted over the satellite communication uplink. In one example implementation, Satcom encoding is based on reencoding the packets using Digital Video Broadcasting (DVB)-compliant Satcom layer-1 protocols. This involves preparing the data for transmission over satellite networks, which can include modulation and forward-error-correction encoding tailored to the DVB Satcom requirements.

The encoded signal is passed through the Satcom RF front end, where it is prepared for RF output/transmission. This can include initial filtering, amplification, and/or frequency conversion to match the satellite uplink requirements. The RF uplink output is then transmitted via the uplink Mux 447 (when selected for conversion) through the RIS component(s) 450 to the NTN satellite 334.

It should be noted that the control signal or the like can also be used to fully bypass the transcoder conversion and thus save compute and power resources. Thus, although the uplink paths in FIG. 4 that are input to the Mux 457 are shown as operating in parallel, this is only one example implementation.

The downlink (receive/RF downlink in) process with respect to reception by the 5G NR-enabled device 332 of the NTN satellite downlink communication signal is shown in the opposite direction in FIG. 4. In general, The NTN satellite 334 transmits an RF downlink (DL) signal, which is received by the RIS component(s) 450. In turn, the RIS component(s) 450 forwards the received signal to the transcoder device with bypass 335 (FIG. 3), and in this example, to the Satcom RF front end component 453 and a D2D 5G NR RF bypass path. Again, while this is shown in parallel in FIG. 4, there can be a selection of one downlink path or the other.

When Satcom-to 5G conversion is needed, the RF downlink signal, which enters the Satcom RF front-end component 453, initially processes the downlink signal, which can include filtering and amplification. The processed RF signal is then decoded (block 454) down to the packet level using DVB logic blocks. This can include equalization, demodulation and forward-error-correction decoding to extract the data packets from the RF signal.

Packet-level transcoding of the downlink signal also operates via packet conversion, that is, the decoded Satcom packets are converted to 5G NR packets. This ensures the data can be accurately and efficiently transmitted over the 5G NR communication link. In general, as shown in FIG. 4, the decoded downlink packets are reencoded (block 455) using 5G NR specific L1-PHY protocols. This involves preparing the data for transmission over the 5G NR network, which can include modulation and forward-error-correction tailored to 5G NR requirements.

The reencoded downlink signal is passed through the 5G NR RF front end component 456, where it is prepared for transmission back to the user equipment 332. This can include filtering, amplification, and/or frequency conversion to match the terrestrial 5G NR downlink requirements. The prepared 5G NR RF downlink output signal is then transmitted, via a downlink Mux 447 (when conversion is selected) back to the user equipment 332 (e.g., a notebook or smartphone).

As with uplink, a downlink (DL) bypass path is also available for D2D 5G NR, e.g., as represented by the downlink input signal being coupled to the other input of the downlink Mux 447 component (block 456). This path can handle any needed frequency conversion, including that the D2D 5G NR bypass path may convert to a different frequency than the original “Satcom-to-5G NR” pipeline. For example, an optional frequency converter in the downlink bypass path (not explicitly shown) may be invoked for situations where the user equipment does not support the 5G NR satellite frequency band(s).

As described herein, the dual-band device includes the downlink multiplexer (DL Mux) 457 that facilitates selecting between which path to take to transmit to the user equipment, namely the transcoder/conversion state for Satcom, or the D2D state 5F NR. A control signal CTL[0] as described herein determines which state is selected. FIG. 4 also shows that the output of the 2×1 Mux 457 is transmitted to the user equipment 332.

In one implementation, the downlink multiplexer 457 is a 2×1 Mux that selects between the downlink “Satcom” pipeline path or the “D2D 5G NR” path. The downlink multiplexer 457 can be a dumb hardware Mux, physically selecting the downlink path, e.g., with no dynamically switching Mux features. Again, for downlink bypass, the entire downlink Satcom conversion path can be bypassed rather than processed in parallel as in FIG. 4.

Turning to controlling the uplink and downlink multiplexer states, in one or more example implementations, the edge compute device 341 runs a number of software modules, including trained models 342. Example trained models 342 include, but are not limited to an AI/software control and switching engine 462, and an AI/software RIS (metasurface) control software engine 463. Although not explicitly shown, the edge compute device 341 can track the satellites' positions, e.g., via an AI/software satellite tracking engine.

In general, the AI/software control and switching engine 462 performs intelligent, dynamic multiplexer control, that is, the AI/software control and switching engine 462 configures the uplink and downlink 2×1 Muxes 447 and 457 (FIG. 4). The AI/software control and switching engine 462 can “circuit-switch” between the Satcom and D2D 5G NR transmit and receive paths, including supporting interleaving of the Satcom and D2D 5G NR uplink and/or downlink communication links. This can be highly beneficial in deployments where the terrestrial and the satellite communication links are overloaded, broken, and/or challenged, e.g., by disaster and weather conditions.

The AI/software RIS software control engine 463 facilitates RIS configuration and programming of the RIS (metasurface). This can include selecting or reconfiguring the uplink/downlink frequencies of the RIS, as well as primary-satellite and secondary-satellite switchover.

The onboard AI/software can track the satellites across the horizon. This allows the AI engines 462 and 463 to seamlessly switch between the primary satellite and the secondary satellite. Note that the handing-over from one LEO satellite to another LEO satellite is a challenging AI model resource-intensive task, and depending upon the satellite constellation, this handover can be as frequent as every twenty minutes. The seamless cutover based on the technology described herein is an appropriate solution, avoiding glitches, delays, and/or errors.

By way of example, consider that the primary satellite is close to leaving the field of view of the RIS, while the secondary satellite has entered the field of view. Satellite tracking can instruct the RIS metasurface control engine 463 to reconfigure its unit cells to redirect the signals to and from the secondary satellite, (which then becomes the new primary satellite); reconfiguration can further occur so as to facilitate use of a narrower/higher gain beam that follows the primary satellite across the horizon until the switch to the secondary satellite. As a further example, consider that the primary satellite supported D2D communications, but the secondary satellite to be switched-to supports Satcom. The AI/SW control engine 462 can change from the multiplexer bypass state to the multiplexer transcoder conversion state, in conjunction with instructing the AI/software RIS software engine 463 to change its operation for Satcom frequency redirection.

Integrating edge computing capabilities into the transcoder box includes adding localized processing power to handle data before the is transmitted to satellite, that is, the edge compute device 341 performs preprocessing. This can significantly reduce latency, optimize bandwidth usage, and enhance the performance of real-time applications. In terms of hardware integration, one implementation shown in FIG. 3 adds a dedicated edge computing device (module) 341 to the transcoder node (device 330). This could be a high-performance embedded system or a small form-factor computing device (like a RASPBERRY PI, NVIDIA JETSON, MULTI-PROCESSOR FPGA, or similar). The edge module 341 is equipped with sufficient storage and memory to handle data processing tasks, including via a data processing framework that efficiently handles data ingestion, processing, and transmission. Ultra-efficient machine learning models can be deployed for tasks such as data filtering, quantized anomaly detection, and predictive analytics. Further, the effective utilization of compute based on prioritization of the services can be employed. For example, if anomaly detection is running in the background, the background compute can be reduced to prioritize any new learning or prediction. In an idle state, deprioritizing certain services can relieve compute resources. To mitigate thermal overhead, maximum power utilization threshold can be set in the anomaly detection, learning, or predictive models.

Still further, the edge compute capabilities of the L1-PHY transcoder system become a distributed-computing architecture. To this end, various L1-PHY-T-boxes can be parallelized to process distributed workloads across the numerous smaller compute nodes. The system can be scalable, allowing for additional edge nodes to be integrated as needed. The AI models can divide and distribute the work across the ground/space-compute network, geared towards space compute opportunities, including, for example, military, government, and science compute needs.

In general, edge computing helps to optimize bandwidth usage by prioritizing critical data and deferring non-urgent data transmissions, which assists in managing the limited and expensive satellite bandwidth more efficiently. Edge computing also provides the capability to preprocess data locally to filter out redundant information, compress data, and perform initial analyses. AI models can (e.g., continuously) optimize data processing and transmission based on real-time network conditions and application requirements.

As described herein, the system also can include remote management capabilities to monitor and update the edge computing module. This includes software updates, configuration changes, and performance monitoring.

To summarize some of the implementation artifacts, data filtering and preprocessing can be based on TENSORFLOW LITE, which is a lightweight version of TENSORFLOW ideal for mobile and embedded devices. It can be used for initial data filtering and preprocessing tasks. PYTORCH MOBILE is another lightweight framework for deploying machine learning models on mobile and edge devices.

Quantized anomaly detection can be based on autoencoders for unsupervised anomaly detection by reconstructing input data and flagging deviations. Isolation forest is a model specifically designed for anomaly detection that can be quantized for edge deployment; One-Class SVM is suitable for detecting anomalies in scenarios where only normal data is available during training.

Predictive analytics can be based on LSTM (Long Short-Term Memory) networks, which is useful for time-series prediction tasks and can be optimized for edge computing. XGBOOST is an efficient and scalable implementation of gradient boosting framework that can be optimized and quantized for edge deployment. Random forest provides robust predictive analytics and can be tuned to run efficiently on edge devices.

Real-time data processing and optimization can be based on reinforcement learning to continuously optimize data processing and transmission based on real-time network conditions. EDGE IMPULSE is a platform designed for building and optimizing machine learning models for edge devices.

Compression and redundant data filtering can leverage principal component analysis (PCA) for reducing data dimensionality and removing redundancy. For visualizing high-dimensional data and identifying redundant patterns, t-SNE (t-Distributed Stochastic Neighbor Embedding) can be utilized.

Frameworks for edge computing can include NVIDIA Jetson platform, which includes tools such as JetPack SDK, which supports TensorRT for optimized inference on Jetson devices, and OpenVINO toolkit, which optimizes models trained in various frameworks to run on certain hardware with minimal latency.

Remote management and monitoring can be based on PROMETHEUS for monitoring and alerting, which can be integrated with edge devices for performance tracking. GRAFANA can be used to create dashboards to visualize the performance of the edge computing modules.

AI models for bandwidth optimization can be based on deep reinforcement learning, such as models like DQN (Deep Q-Network) or A3C (Asynchronous Advantage Actor-Critic); these can be used to dynamically optimize data transmission. Bayesian optimization facilitates tuning hyperparameters and optimizing the performance of machine learning models on the edge.

Efficient inference models include MobileNet, a lightweight, efficient model for image processing tasks that can be deployed on edge devices, and YOLO (You Only Look Once) for real-time object detection, optimized for edge computing. Quantized models for post-training quantization are available techniques in TENSORFLOW LITE or PYTORCH to reduce the size and computational requirements of models for edge devices.

Thus, to summarize, the implementation uses hardware integration of the edge computing module. This includes the physical installation of devices such as a Raspberry Pi or NVIDIA Jetson onto the transcoder node, ensuring they are connected to the necessary power and network sources. The module can be configured with a data processing framework capable of handling data ingestion, processing, and transmission efficiently. Frameworks such as TENSORFLOW LITE or PYTORCH MOBILE can be utilized for deploying lightweight machine learning models on these devices. These models will be responsible for initial data filtering and preprocessing, removing redundant information, compressing data, and performing initial analyses.

For anomaly detection, quantized models such as Autoencoders, Isolation Forest, or One-Class SVM can be used, which can be optimized for edge deployment. These models continuously monitor data to detect any anomalies, ensuring that only relevant (e.g., critical) data is prioritized for transmission. During periods of background anomaly detection, the system can reduce compute resources allocated to less critical tasks, prioritizing new learning or prediction processes. This dynamic allocation of resources helps in optimizing overall system performance and reducing thermal overhead by setting a maximum power utilization threshold. In terms of predictive analytics, models like LSTM (Long Short-Term Memory) networks, XGBoost, and Random Forest can be deployed. These models are well-suited for tasks such as time-series prediction and can be tuned to run efficiently on edge devices. For real-time data processing and optimization, reinforcement learning techniques, including DQN (Deep Q-Network) and A3C (Asynchronous Advantage Actor-Critic), can be employed to dynamically adjust data processing and transmission strategies based on current network conditions.

To further optimize bandwidth usage, edge computing modules can implement AI models that continuously optimize data processing and transmission. Deep reinforcement learning models can be trained to prioritize critical data and defer non-urgent transmissions, ensuring the efficient management of limited and expensive satellite bandwidth. Additionally, compression techniques such as principal component analysis (PCA) and t-SNE (t-Distributed Stochastic Neighbor Embedding) can be used to reduce data dimensionality and filter out redundant information before transmission. The system also includes remote management capabilities to monitor and update the edge computing modules. Using platforms for monitoring and visualization, the system can track the performance of each edge device, ensuring they operate optimally. Remote management also allows for software updates, configuration changes, and performance monitoring, ensuring the system remains scalable and efficient as additional edge nodes are integrated.

By deploying these efficient inference models, such as for image processing tasks and real-time object detection, the system can ensure that data processing tasks are handled swiftly and accurately on the edge. The use of post-training quantization techniques in suitable frameworks further reduce the size and computational requirements of the models, making them suitable for deployment on resource-constrained edge devices. One approach to integrating edge computing into the transcoder box not only enhances real-time application performance but also optimizes bandwidth usage and reduces latency. By leveraging advanced AI models and frameworks, the system is able to process and transmit data efficiently, ensuring seamless operation and scalability as the network of edge devices expands.

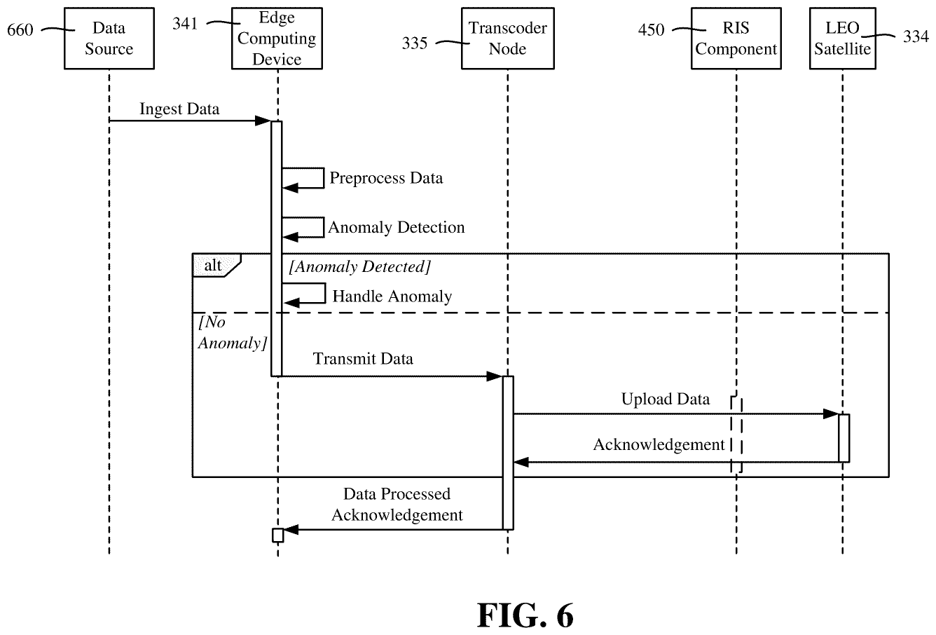

The sequence diagram shown in FIG. 5 illustrates the interaction flow between a user equipment 332, edge computing device (module) 341, transcoder node/device 335, and (via a RIS component 450) a LEO in a data processing system. One example process begins with the user equipment 332 providing data to the edge computing device 341. The edge computing device 341 preprocesses the data and then sends the preprocessed data to the transcoder node 335 for further processing. The transcoder node 335 performs anomaly detection and predictive analytics on the data. Once these analyses are complete, the transcoder node 335 uploads the processed data to the satellite 334. The satellite 334 acknowledges receipt of the data and sends an acknowledgement back to the transcoder node 335. The transcoder node 335 communicates the data processed acknowledgement back to the edge computing device 341, completing the cycle. FIG. 5 demonstrates sequential interaction between the components, emphasizing the roles of preprocessing, anomaly detection, predictive analytics, and data transmission in the overall workflow.

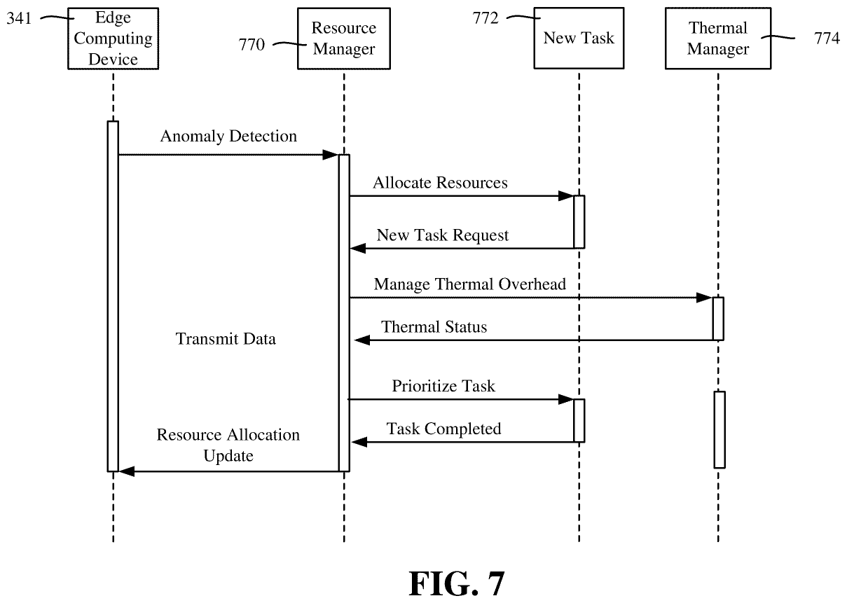

The sequence diagram shown in FIG. 6 depicts the data processing workflow involving a data source 660, edge computing device 341, transcoder node 335, RIS component 450 and satellite 334, with a focus on anomaly detection and data transmission. The example process begins with the data source 660 ingesting data into the edge computing device 341. The edge computing device 341 preprocesses the data and then performs anomaly detection. If an anomaly is detected, the edge computing device 341 handles the anomaly internally. If no anomaly is detected, the edge computing device 341 transmits the data to the transcoder node 335. The edge computing device 341 then deactivates, and the transcoder node 335 takes over, uploading the data via the metasurface 450 to the satellite 334. Upon successful upload, the satellite 334 sends an acknowledgement back to the transcoder node 335. The transcoder node 335 then informs the edge computing device 341 that the data has been processed, completing the cycle. The use of alternate paths (alt) in the diagram highlights the decision point for anomaly detection, showing different actions based on whether an anomaly is found or not. This proposed process ensures efficient data handling, anomaly management, and reliable data transmission to the satellite.

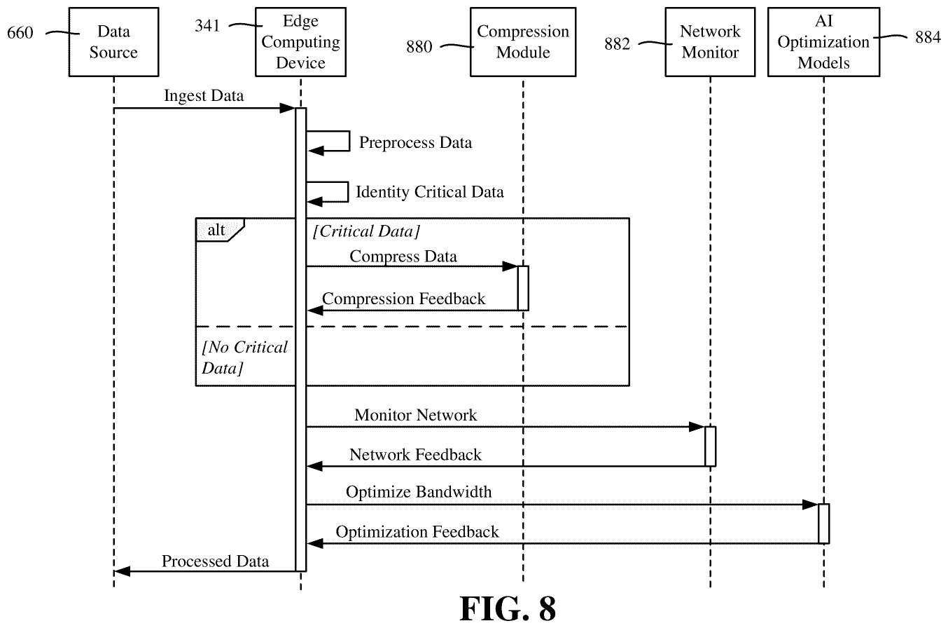

The sequence diagram shown in FIG. 7 outlines the process of anomaly detection and resource management within an edge computing environment. The workflow begins with the edge computing device 341 detecting an anomaly and notifying a resource manager 770. Upon receiving the anomaly detection signal, the resource manager 770 allocates resources and activates a new task 772. The new task 772 sends a request back to the resource manager 770 and then deactivates.

The resource manager 770 then interacts with the thermal manager 774 to manage thermal overhead. The thermal manager 774 provides thermal status feedback to the resource manager 770, and then deactivates. Following this, the resource manager 770 prioritizes the task and reactivates the new task 772, which completes the task and notifies the resource manager 770. The resource manager 770 updates the edge computing device 341 about the resource allocation status before deactivating. FIG. 7 emphasizes the interactions between the edge computing device 341, resource manager 770, new task 772, and thermal manager 774, illustrating the steps involved in anomaly detection, resource allocation, task prioritization, and thermal management, ensuring efficient and effective operation within the edge computing system.

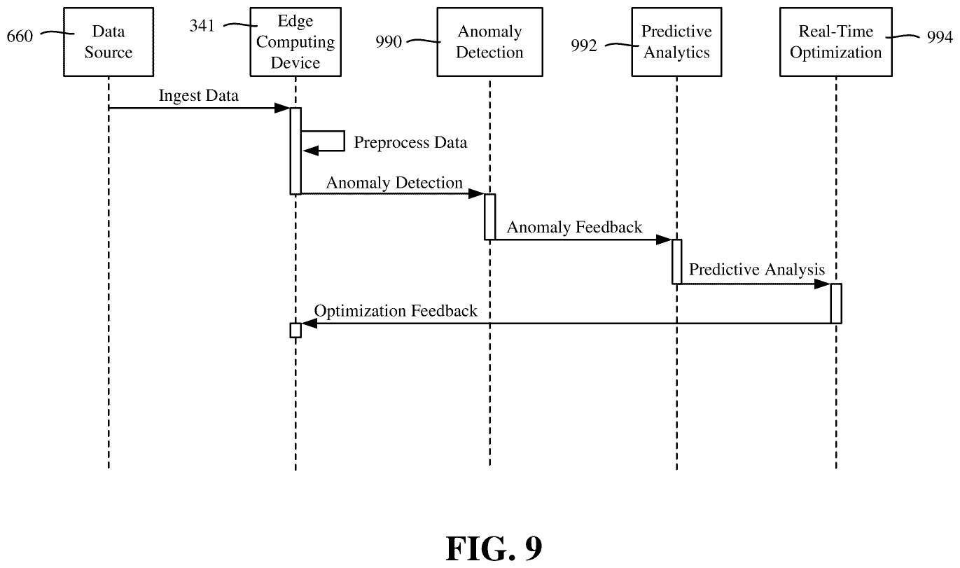

The sequence diagram shown in FIG. 8 illustrates the bandwidth optimization process involving interactions between the data source 660, edge computing device 341, compression module 880, network monitor 882, and AI optimization models. The process begins with data ingestion by the edge computing device 341, followed by data preprocessing and critical data identification. If critical data is detected, it is sent to the compression module 880 for compression; otherwise, the process continues without compression. The edge computing device 341 then sends data to the network monitor 882 for network monitoring, receiving network feedback, and subsequently interacts with the AI optimization models 884 for bandwidth optimization based on this feedback. The edge computing device 341 returns the processed and optimized data to the data source 660.

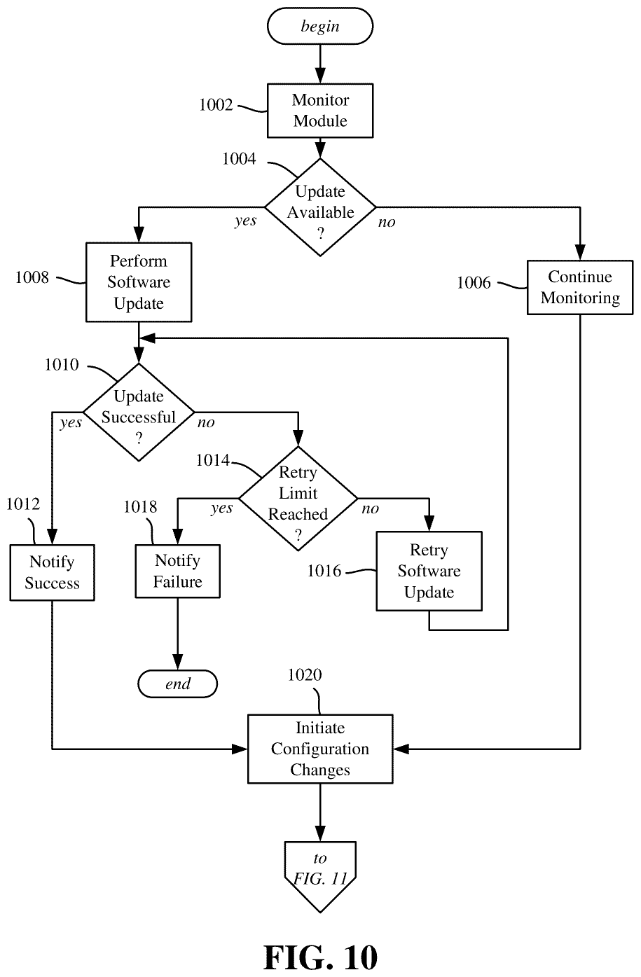

The sequence diagram shown in FIG. 9 illustrates the integration of AI models within the bandwidth optimization process described herein, highlighting certain interactions between the data source 660, edge computing device 341, anomaly detection (module) 990, predictive analytics (module) 992, and real-time optimization (module) 994. The process begins with the edge computing device 341, which preprocesses the data, ingesting data from the data source 660. The edge computing device 341 then engages the anomaly detection module 990 to detect any anomalies in the data. Upon completing anomaly detection, the anomaly detection module 990 provides feedback to the predictive analytics module 992, which performs predictive analysis based on the data. The predictive analytics module 992 then passes its findings to the RO module for real-time optimization. Finally, the real-time optimization module 994 sends optimization feedback back to the edge computing device 341, completing the process. Such an integration of AI models ensures a seamless flow of data through various analytical stages, enhancing the system's ability to detect anomalies, make predictions, and optimize operations in real-time, thereby improving overall efficiency and performance.

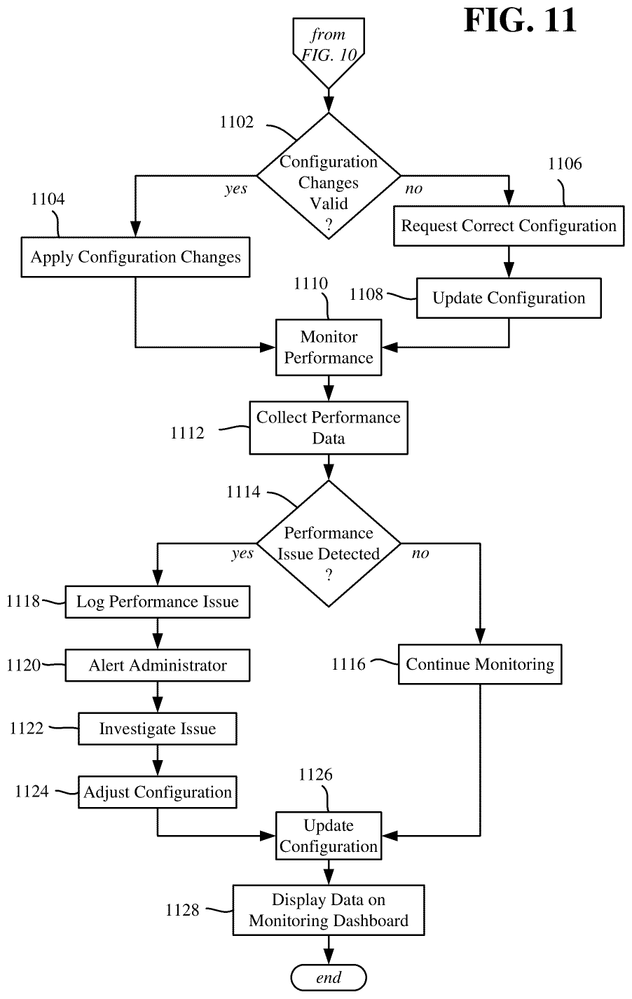

FIGS. 10 and 11 show an example of a remote management and monitoring process as example operations in a flow diagram. Example operation 1002 of FIG. 10 starts with a user initiating the monitoring module via a remote management platform. As evaluated at example operation 1004, if no software update is available, the process continues monitoring (example operation 1006), and continues to initiate configuration changes (example operation 1020).

Otherwise, if a software update is available, the remote management platform performs the update (example operation 1008) on the edge computing device 341, with conditional checks for success (example operation 1010). If the update is successful, a success notification is sent as represented via example operation 1012. Otherwise, via operations 1014 and 1016, the system retries the update until success; a failure notification is issued as represented via example operation 1018 upon reaching the retry limit. The remote management platform then initiates configuration changes as represented via example operation 1020, which continues to example operation 1102 of FIG. 11.

Example operation 1102 of FIG. 11 begins with the validation of these configuration changes. Valid changes are applied (example operation 1104), while invalid changes prompt a request for correction and subsequent updates (example operations 1106 and 1108).

As represented via example operation 1110, the remote management platform monitors performance, e.g., through a performance monitor, collecting performance data at example operation 1112. If no performance issue is detected as evaluated via example operation 1114, the process continues monitoring at example operation 1116, and continues to example operation 1126 to update the configuration.

If a performance issue is detected at example operation 1114, the system logs the issue (example operation 1118), alerts the administrator (example operation 1120), investigates the issue (example operation 1122), and adjusts the configuration accordingly (example operation 1124). The process continues to example operation 1126 to update the configuration.

As represented via example 1128, the updated configurations and performance data are displayed on a monitoring dashboard or the like. As can be seen, the conditional checks and feedback loops in the example operations of the flow diagram of FIGS. 10 and 11 provide a step-by-step visualization of the remote management and monitoring process.

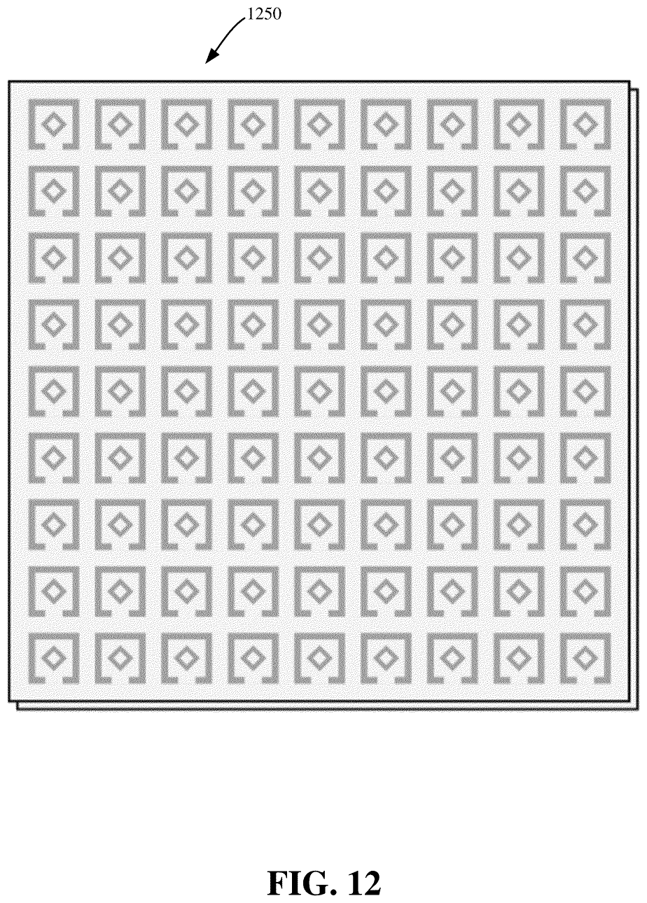

Turning to addition details of the metasurface (RIS), FIG. 12 shows the concept of a metasurface 1250 of unit cells. Although not explicitly represented in FIG. 12, one such metasurface can be portable, and can have a metal back plane (e.g., a solid metal sheet) selectively (e.g., manually) attached for reflection mode (R-mode) or detached, whereby the panel works in transmission mode (T-mode). Thus, in one implementation, a complete panel (which can be portable) can include two physical sections; one section is the array of metasurface unit cells (FIG. 12) patterned on a metal layer formed on the dielectric substrate, while the second is a detachable/attachable solid metal sheet that functions as a back plane. When the metal panel is attached to the back of the metasurface array, the metasurface 1250 inherently operates in the reflection mode, bouncing the enhanced signals back in the reflecting direction, allowing signals to be reflected from the panel with improved signal strength due to array gain from constructive interference, resulting from different configured phase shifts of the unit cells. When the metasurface is used without the back plane, it operates in a transmission mode, allowing signals to pass through the panel with improved signal strength due to array gain from constructive interference, via refraction of the signal. In one design implementation, a magnetic attachment system can be used to couple the back plane to the underside of the unit cell surface, which simplifies the alignment when transitioning between transmissive and reflective operating modes. By simply placing or removing the back plane, a user can switch the metasurface between its two modes of operation, making the system highly adaptable for different communication scenarios.

In one or more example implementations, a passive portable metasurface can be manually configured to operate either in reflection mode (R-Mode) or in transmission mode (T-mode) to service various device(s)/UE(s). Such portable metasurfaces can be designed in a way to offer signal boost in the 3GPP standardized non-terrestrial network bands without requiring any power source, providing indoor usage scenarios as well as a travel-ready solution for remote areas, and/or during emergency situations when power is not available. It should be noted that while such an inexpensive back plane option allows straightforward reconfiguration of the operating modes of a metasurface, this is a non-limiting example. For example, one user may want a ceiling-mounted metasurface for operating only in the transmission mode, and can thus purchase one without a back plane. In contrast, a different user may want a window-mounted backplane for operating only in the reflection mode, and can purchase a metasurface with a fixed (non-detachable) back plane for presumably less cost than a metasurface with a selectively detachable back plane.

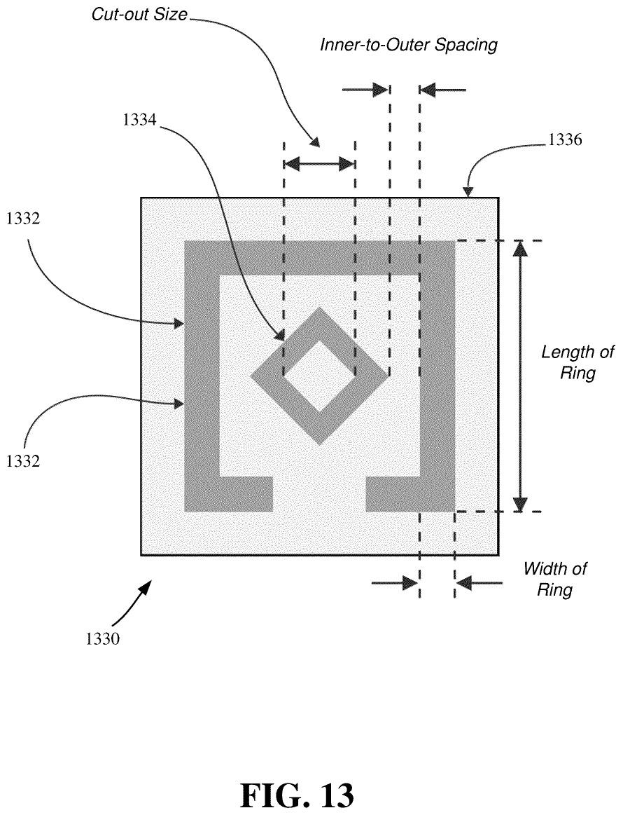

FIG. 13 shows one example design of a unit cell 1330 of a metasurface. In this example, the unit cell 1330 has a metallic resonating pattern shaped as square split ring (outer shape 1332) with a central rhombus (inner shape 1334). The pattern is formed from a thin metal film on a dielectric substrate 1336. The dimensions of the unit cell 1330 determine the frequency at which the unit cell resonates, and are thus sized based on the frequency band of the incoming signal, e.g., the n255 or n256 satellite bands. Smaller dimensions can be used for higher frequencies, such as millimeter wave/FR2 frequencies. Note that FIG. 13 is only one non-limiting example, and that the metallic resonator pattern of a unit cell can be of any shape and size as long as the metallic resonator pattern resonates at the desired frequency.

Scaling of the rhombus shape, or by rotating the inner shape 1334, allows the phase of the unit-cell to be tweaked; in this way, a metasurface's unit cells can be coded as per the phase-codebook of the metasurfaces for beam redirection, given an incoming signal from a known general direction relative to the metasurface, e.g., from the sky for a satellite. Various design dimensions are shown in FIG. 13 to better illustrate the optimization variables. This shape of the unit-cell can be developed on any choice of commonly available dielectrics including but not limited to FR4 laminates, Rogers RF substrates, alumina, sapphire, glass, ceramics, or other non-metallic substrates, as long as the unit-cell shows a resonance peak at the desired frequency.

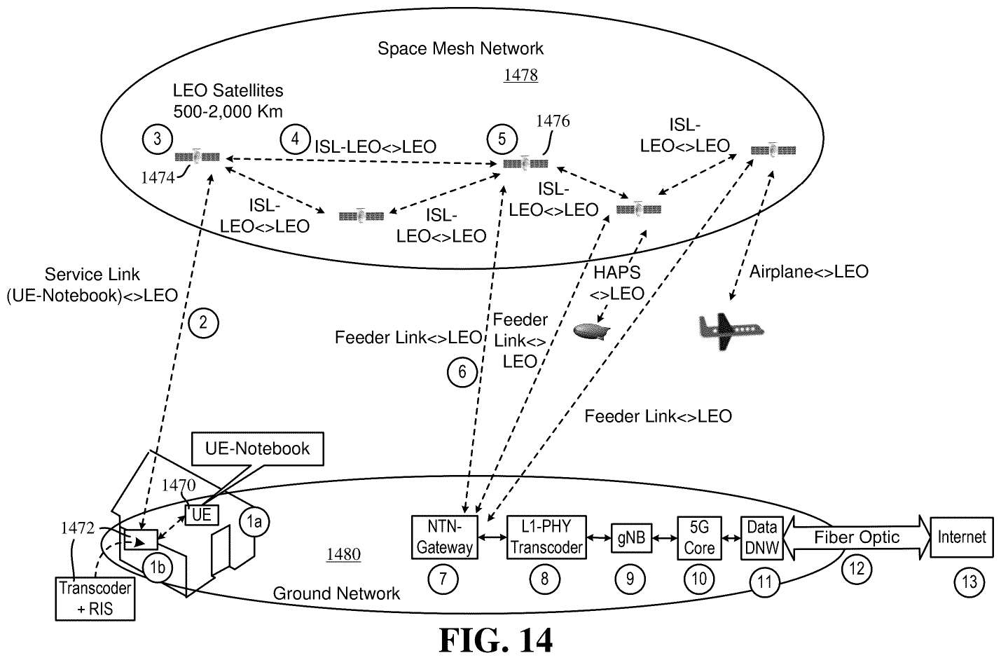

In general, non-terrestrial network airborne networks may be intra-continent, or span across oceans and multiple continents, as a non-terrestrial network is a global network. By way of example, consider the travels/life of a data packet in a system-level end-to-end network as generally represented in FIG. 14, in which acronyms include inter-satellite link (ISL), low earth orbit (LEO) and high-altitude platform systems (HAPS).

The example of FIG. 14 shows a non-terrestrial network direct-to-device end-to-end deployment of a UE (notebook computer) and provides a life-of-a-packet description, in which circled numerals represent communications (alphanumerically labeled arrows) and components/component operations (numerically labeled blocks). Analysis of the packet starts inside a home, e.g., on the East coast of the United States, in which a notebook computer 1470 is shielded by a house roof, walls, windows, and/or doors.

Labeled arrow (1a) represents packets leaving the notebook 1470. Arrow (1b) represents the packets, transcoded to Satcom or bypassed to 5G NR, being reflected out of the interior of the home using the metasurface panel technology (RIS 1472) described herein.

Arrow (2) represents the packets traveling through the satellite air interface to a first LEO satellite 1474 using the service-link. Once inside the satellite (labeled block (3)), the Satcom (converted from 5G NR) channel packet or 5G NR channel packet is repeated (amplified/frequency-converted).

At arrow (4), the Satcom or 5G packet leaves the first LEO satellite 1474 through the space mesh network 1478 using the “Optical Inter-Satellite Arrow Links (ISL)”, more specifically the “ISL-LEO-LEO” link. The space mesh network 1478 is basically a router/switch in space, represented by arrow (4) passing the packets through the space network; (note that multiple space network hops are possible, both LEO and GEO (geostationary earth orbit) satellite hops). The satellite physical interface is the inter-satellite links (ISL), similar to the optical interfaces used in ground networks.

Once the Satcom or 5G packet gets close to its destination, in this example it is in the western part of the United States, the packet terminates (labeled block (5)) inside the second LEO satellite 1476. As represented by arrow (6), the Satcom/5G packet is then exported out of the second LEO satellite 1476 through the radio-frequency (RF) feeder-link downlink connection. Thus, as represented by block (7), the packets pass through the non-terrestrial network gateway, and if Satcom are converted back to 5G packet data at block (8), then at block (9) through the gNodeB (gNB 5G Radio Access Network), and at block (10) to the 5G Core (5GC). As represented by block (11), via the standard data network, the data network block is the transcoder-block from the mobile-network to standard ground data network. The 5G NR tunneled packet is demodulated back to the original baseband packet format and processed into the data network as a typical Internet Protocol (IP) packet, thus processed through commercial-off-the-shelf routers and switches.

As represented by block (12), once the IP packet routes through the traditional fiber data network (DNW), the packet enters the Internet connection. At block (13), once the data is retrieved from the Internet, the read-return packet can be sent through the same exact ground-network 1480 and space mesh network 1478, returning the read-return packet to the notebook UE 1470.

In sum, the technology described herein facilitates a universal dual-RF front end L1-PHY transcoder device (box), which can be a low-cost, low-intelligence (hardware solution, no additional software), for straightforward configuration and operation. The L1-PHY transcoder can be separated from the RIS components to again lower-the cost/complexity. This device can be implemented as a small, light box, which can be implemented in a physical footprint/form factor as small as the size of a cellphone, for example.

In general, for Satcom communications, a packet-level transcoding methodology decodes signals down to the packet-level using 3GPP 5G NR logic blocks before re-encoding them for DVB satellite satcom communication (and vice versa), ensuring high fidelity and minimal data loss. This approach maintains the integrity of the data while allowing efficient transcoding between different communication protocols. Bypass is available for 5G-direct-to-device communications, in both uplink and downlink directions. The L1-PHY device can include additional included features, such as (but not limited) doppler shifting/correction/compensation, frequency up/down converter, modulator/demodulator, frequency equalization, negative-slope compensation, repeater, re-clocking, amplification, power levels, and so on. Note that the doppler compensation technique can be hardware-based/physical doppler-shift compensation that dynamically corrects doppler as the satellite moves across the horizon; this needs no modification to the UE. Frequency conversion can include mobile network operator (MNO)-to-Satcom frequency (band) conversion and Satcom-to-MNO frequency (band) conversion.

The RIS provides the LOS connectivity to the satellites, and also facilitates portability and disaggregation. The indoor RF signal is converted using the transcoding technology described herein, and then uses the RIS to achieve line-of-sight connectivity directly to the satellite. The RIS technology provides the capability to transmit the RF signal outdoor to the indoor environment and transmit UE signal from indoor to outdoor wirelessly, eliminating the needs of a physical cable connecting outdoor antenna and indoor UEs, which adds the benefit of portability.

One or more embodiments can be embodied in a system, such as described and represented in the drawing figures herein. The system can include a metasurface, and a device. The device can include a Layer-1 physical interface (L1-PHY) uplink transcoder path, an uplink bypass path, an uplink multiplexer that can include a first uplink multiplexer input coupled to the L1-PHY uplink transcoder path, a second uplink multiplexer input coupled to the uplink bypass path, and an uplink multiplexer output coupled to the metasurface. The L1-PHY uplink transcoder path can convert terrestrial uplink communication signals from a user equipment configured for cellular telecommunications to non-terrestrial uplink satellite communication (Satcom) signals, and cab route the non-terrestrial uplink communication signals to the first uplink multiplexer input. The uplink bypass path bypasses the L1-PHY uplink transcoder path, and can route the terrestrial uplink communication signals as direct-to-device non-terrestrial uplink communication signals to the second uplink multiplexer input. The device can include L1-PHY downlink transcoder path coupled to the metasurface, a downlink bypass path coupled to the metasurface, a downlink multiplexer that can include a first downlink multiplexer input coupled to the L1-PHY downlink transcoder path, a second downlink multiplexer input coupled to the downlink bypass path, and a downlink multiplexer output coupled to the user equipment. The L1-PHY downlink transcoder path can convert non-terrestrial downlink Satcom signals, obtained from a satellite via the metasurface, to terrestrial downlink communication signals, and can route the terrestrial downlink communication signals to the first downlink multiplexer input. The downlink bypass path bypasses the L1-PHY downlink transcoder path, and can route direct-to-device non-terrestrial downlink communication signals, obtained from the satellite via the metasurface, as terrestrial uplink communication signals to the second downlink multiplexer input. The device can include an edge compute device that can perform data preprocessing on the terrestrial uplink communication signals, and that can execute a switching and control model. The switching and control model can select between a first uplink multiplexer state that couples the first uplink multiplexer input to the uplink multiplexer output, or a second uplink multiplexer state that couples the second uplink multiplexer input to the uplink multiplexer output, and can select between a first downlink multiplexer state that couples the first downlink multiplexer input to the downlink multiplexer output, or a second downlink multiplexer state that couples the second downlink multiplexer input to the downlink multiplexer output.

The data preprocessing can perform data filtering on the terrestrial uplink communication signals.

The data preprocessing can perform anomaly detection on the terrestrial uplink communication signals.

The data preprocessing can perform predictive analytics on the terrestrial uplink communication signals.

The data preprocessing can perform data compression on the terrestrial uplink communication signals.

The data preprocessing can filter redundant data from the terrestrial uplink communication signals.

The edge compute device can perform bandwidth optimization corresponding to transmitting the terrestrial uplink communication signals.

The edge compute device can perform management and monitoring.

The edge compute device can perform prioritization of services; the services that can include the data preprocessing, the management, and the monitoring.

The device can be incorporated into a transcoder device structure, and the transcoder device structure can be one transcoder device structure of a group of transcoder device structures operating in parallel.

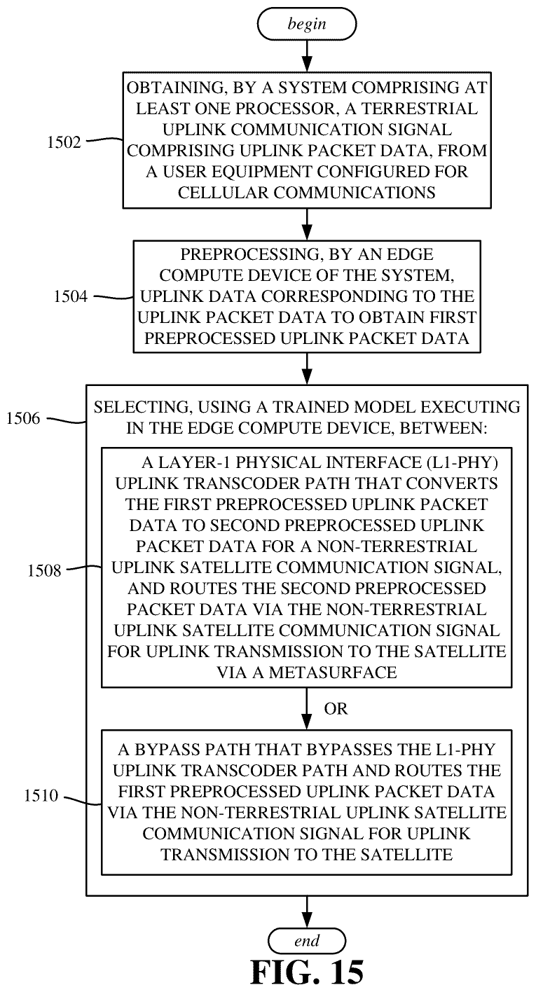

One or more example implementations and embodiments, such as corresponding to example operations of a method, or computer executable instructions/components can be represented in FIG. 15. Example operation 1502 represents obtaining, by a system that can include at least one processor, a terrestrial uplink communication signal that can include uplink packet data, from a user equipment configured for cellular communications. Example operation 1504 represents preprocessing, by an edge compute device of the system, uplink data corresponding to the uplink packet data to obtain first preprocessed uplink packet data. Example operation 1506 represents selecting, using a trained model executing in the edge compute device, between a Layer-1 physical interface (L1-PHY) uplink transcoder path that converts the first preprocessed uplink packet data to second preprocessed uplink packet data for a non-terrestrial uplink satellite communication signal, and routes the second preprocessed packet data via the non-terrestrial uplink satellite communication signal for uplink transmission to the satellite via a metasurface (example block 1508), or a bypass path that bypasses the L1-PHY uplink transcoder path and routes the first preprocessed uplink packet data via the non-terrestrial uplink satellite communication signal for uplink transmission to the satellite (example block 1510).

Preprocessing the uplink data can include at least one of: filtering the uplink data, detecting an anomaly in the uplink data, applying predictive analytics to the uplink data, compressing the uplink data, or optimizing bandwidth usage corresponding to the uplink data.

Further operations can include administering, by the edge compute device, at least one of: the uplink transcoder path, the downlink transcoder path, or the trained model.

Further operations can include obtaining, by the system, a non-terrestrial downlink communication signal that can include first downlink packet data, from the satellite via the metasurface, and selecting, using the trained model, between an L1-PHY downlink transcoder path that converts the first downlink packet data to second downlink packet data for a non-terrestrial uplink satellite communication signal, and routes the second downlink packet data for downlink transmission to user equipment, or a bypass path that bypasses the L1-PHY downlink transcoder path and routes the first downlink packet data for downlink transmission to user equipment.

One or more embodiments can be embodied in a device, such as described and represented in the drawing figures herein. The device can include a Layer-1 physical interface (L1-PHY) transcoder device; the L1-PHY transcoder device that can include a downlink transcoder path, a downlink bypass path, an uplink transcoder path, and an uplink bypass path. The device can include an edge compute device that performs data preprocessing on terrestrial uplink communication signals, obtained from a user equipment configured for cellular telecommunications, to be transmitted to a satellite via a metasurface, and executes a trained selection model. The trained selection model can be usable to select the uplink transcoder path to convert the terrestrial uplink communication signals from the user equipment, received by the L1-PHY transcoder device, to non-terrestrial uplink communication signals for uplink transmission to the satellite via the metasurface. The trained selection model can be usable to select the uplink bypass path to route the terrestrial uplink communication signals from the user equipment as the non-terrestrial uplink communication signals for the uplink transmission to the satellite via the metasurface. The trained selection model can be usable to select the downlink transcoder path to convert non-terrestrial downlink communication signals from the satellite, received by the L1-PHY transcoder device as redirected via the metasurface, to terrestrial downlink communication signals for downlink transmission to the user equipment. The trained selection model can be usable trained selection model can be usable to select the downlink bypass path to route the non-terrestrial downlink communication signals from the satellite as the terrestrial downlink communication signals for the downlink transmission to the user equipment.

The data preprocessing can perform at least one of: data filtering on the terrestrial uplink communication signals, anomaly detection on the terrestrial uplink communication signals, predictive analytics on the terrestrial uplink communication signals, or data compression on the terrestrial uplink communication signals.

The data preprocessing can at least one of: filter redundant data from the terrestrial uplink communication signals, or perform bandwidth optimization corresponding to the uplink transmission of the terrestrial uplink communication signals.

The edge compute device can perform management and monitoring of at least one of: the L1-PHY transcoder device, or the trained selection model.

The edge compute device can perform prioritization of services; the services that can include the data preprocessing and the management and monitoring.

The edge compute device can be incorporated into a transcoder device structure that can include the L1-PHY transcoder device, and the transcoder device structure can be one transcoder device structure of a group of transcoder device structures operating in parallel.

As can be seen, the technology described herein can be based on L1-PHY transcoder technology and metasurface (RIS) technology, in which the transcoder converts between the Satcom-air-interface and the 3GPP-5G-NR-air-interface, including decoding and reencoding data packets at the L1-PHY packet level, or operates in a bypass mode for D2D communications. A controller, e.g., a control and switching AI engine, controls uplink and downlink multiplexer states to select between the transcoder conversion mode or the bypass mode. This device can be implemented in an L1-PHY appliance that allows a 3GPP-compliant 5G NR model to connect directly to legacy and future LEO satellite constellations.

The integration of edge computing and advanced AI models into transcoder nodes brings various benefits. By processing and filtering data at the edge, the system significantly reduces the volume of data that needs to be transmitted via satellite, optimizing bandwidth usage, and lowering communication costs. Such localized processing minimizes latency, ensuring timely and accurate data analysis for real-time applications, which enhances the overall performance and responsiveness of the system. Additionally, the use of efficient AI models for anomaly detection, predictive analytics, and real-time optimization ensures that appropriate (e.g., critical) data is prioritized, whereby non-urgent data transmissions are deferred, making the system more efficient and reliable.

Note that as space network architects are beginning to build new satellite deployments, the edge compute capabilities are beneficial for space distributed-compute/storage and communications. A challenge is the amount of compute horsepower, power (Watts), thermal cooling, real estate, and space-hardened compute silicon; described herein is moving the edge computing function as close as reasonable to the NTN LEO satellite, but on the ground. This edge compute technology has very low latency, with increased power (Watts), and sufficient real estate to house the solution.

Moreover, the system is designed to be scalable and flexible, accommodating a growing network of edge nodes. The modular design allows for easy integration of additional devices, while the robust remote management capabilities, utilizing existing platforms, enable real-time performance monitoring, software updates, and configuration changes. This ensures that the system remains adaptable to evolving network demands and maintains optimal performance over time. Dynamic resource management and thermal overhead control further support sustainable and cost-effective operation, making this solution viable for widespread deployment in various real-time data processing applications.

The technology described herein thus allows user equipment that communicates using the 3GPP 5G NR mobile wireless language to communicate with satellites of a satellite constellation, both legacy constellations and newer constellations recently deployed, by passing the signals through the L1-PHY transcoder box. For non-LoS scenarios, e.g., indoor-located user equipment, communication with non-terrestrial network satellites is facilitated by using metasurface (reconfigurable intelligent surface) technology.

The technology described herein enhances signal reliability and quality by facilitating seamless communication between 5G NR and satellite networks. By enabling standard 5G-enabled devices to access satellite communication services, the transcoder box addresses the digital divide, providing broadband access to rural and underserved communities, for example. The dual RF front-end integration, packet-level transcoding, and NTN constellation agnostic connectivity collectively ensure robust and high-quality communication links.

As one example use case, such switching between the two air interfaces can be extremely beneficial in a disaster-relief emergency deployment where cellular (terrestrial) and NTN (satellite) communication can be spotty. Another use case is providing a universal communication device to the rural/underserved communities. Thus, the technology described herein transcodes the Satcom industry standard air-interface to the terrestrial mobile wireless standard, and vice-versa, while also enabling D2D communications between a UE and a satellite. In addition to packet-level conversion when needed, example protocols and resources that can convert, through the transcoding process, include, but are not limited to, doppler shifting/correction/compensation, frequency up/down conversion, modulator/demodulator, frequency equalization, negative-slope compensation, repeater, re-clocking, amplification, power levels, and the like.

The scalable and cost-effective design makes the solution economically viable, allowing for incremental upgrades and expansions, reducing initial deployment costs, while ensuring long-term adaptability to evolving network demands. By maintaining high signal quality and reducing latency, the solution enhances user experience.

The technology described herein enables UEs to connect to virtually any NTN constellation, rather than being limited to a single satellite provider's constellation. By supporting multiple satellite providers, the transcoder ensures continuous connectivity and improves coverage.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As used in this application, the terms “component,” “system,” “platform,” “layer,” “selector,” “interface,” and the like are intended to refer to a computer-related resource or an entity related to an operational apparatus with one or more specific functionalities, wherein the entity can be either hardware, a combination of hardware and software, software, or software in execution. As an example, a component can be an apparatus with specific functionality provided by mechanical parts operated by electric or electronic circuitry. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
a metasurface; and
a device comprising:
a Layer-1 physical interface (L1-PHY) uplink transcoder path,
an uplink bypass path,
an uplink multiplexer comprising a first uplink multiplexer input coupled to the L1-PHY uplink transcoder path, a second uplink multiplexer input coupled to the uplink bypass path, and an uplink multiplexer output coupled to the metasurface,
wherein the L1-PHY uplink transcoder path converts terrestrial uplink communication signals from a user equipment configured for cellular telecommunications to non-terrestrial uplink satellite communication (Satcom) signals, and routes the non-terrestrial uplink communication signals to the first uplink multiplexer input, and wherein the uplink bypass path bypasses the L1-PHY uplink transcoder path, and routes the terrestrial uplink communication signals as direct-to-device non-terrestrial uplink communication signals to the second uplink multiplexer input,
an L1-PHY downlink transcoder path coupled to the metasurface,
a downlink bypass path coupled to the metasurface,
a downlink multiplexer comprising a first downlink multiplexer input coupled to the L1-PHY downlink transcoder path, a second downlink multiplexer input coupled to the downlink bypass path, and a downlink multiplexer output coupled to the user equipment,
wherein the L1-PHY downlink transcoder path converts non-terrestrial downlink Satcom signals, obtained from a satellite via the metasurface, to terrestrial downlink communication signals, and routes the terrestrial downlink communication signals to the first downlink multiplexer input, and wherein the downlink bypass path bypasses the L1-PHY downlink transcoder path, and routes direct-to-device non-terrestrial downlink communication signals, obtained from the satellite via the metasurface, as terrestrial uplink communication signals to the second downlink multiplexer input, and
an edge compute device that:
performs data preprocessing on the terrestrial uplink communication signals, and
executes a switching and control model, the switching and control model:
selecting between a first uplink multiplexer state that couples the first uplink multiplexer input to the uplink multiplexer output, or a second uplink multiplexer state that couples the second uplink multiplexer input to the uplink multiplexer output, and
selecting between a first downlink multiplexer state that couples the first downlink multiplexer input to the downlink multiplexer output, or a second downlink multiplexer state that couples the second downlink multiplexer input to the downlink multiplexer output.

2. The system of claim 1, wherein the data preprocessing performs data filtering on the terrestrial uplink communication signals.

3. The system of claim 1, wherein the data preprocessing performs anomaly detection on the terrestrial uplink communication signals.

4. The system of claim 1, wherein the data preprocessing performs predictive analytics on the terrestrial uplink communication signals.

5. The system of claim 1, wherein the data preprocessing performs data compression on the terrestrial uplink communication signals.

6. The system of claim 1, wherein the data preprocessing filters redundant data from the terrestrial uplink communication signals.

7. The system of claim 1, wherein the edge compute device performs bandwidth optimization corresponding to transmitting the terrestrial uplink communication signals.

8. The system of claim 1, wherein the edge compute device performs management and monitoring.

9. The system of claim 8, wherein the edge compute device performs prioritization of services, the services comprising the data preprocessing, the management, and the monitoring.

10. The system of claim 1, wherein the device is incorporated into a transcoder device structure, and wherein the transcoder device structure is one transcoder device structure of a group of transcoder device structures operating in parallel.

11. A method, comprising:
obtaining, by a system comprising at least one processor, a terrestrial uplink communication signal comprising uplink packet data, from a user equipment configured for cellular communications;
preprocessing, by an edge compute device of the system, uplink data corresponding to the uplink packet data to obtain first preprocessed uplink packet data;
selecting, using a trained model executing in the edge compute device, between:
a Layer-1 physical interface (L1-PHY) uplink transcoder path that converts the first preprocessed uplink packet data to second preprocessed uplink packet data for a non-terrestrial uplink satellite communication signal, and routes the second preprocessed packet data via the non-terrestrial uplink satellite communication signal for uplink transmission to the satellite via a metasurface, or
a bypass path that bypasses the L1-PHY uplink transcoder path and routes the first preprocessed uplink packet data via the non-terrestrial uplink satellite communication signal for uplink transmission to the satellite.

12. The method of claim 11, wherein the preprocessing of the uplink data comprises at least one of: filtering the uplink data, detecting an anomaly in the uplink data, applying predictive analytics to the uplink data, compressing the uplink data, or optimizing bandwidth usage corresponding to the uplink data.

13. The method of claim 11, further comprising administering, by the edge compute device, at least one of: the uplink transcoder path, the downlink transcoder path, or the trained model.

14. The method of claim 11, further comprising:
obtaining, by the system, a non-terrestrial downlink communication signal comprising first downlink packet data, from the satellite via the metasurface;
selecting, using the trained model, between:
an L1-PHY downlink transcoder path that converts the first downlink packet data to second downlink packet data for a non-terrestrial uplink satellite communication signal, and routes the second downlink packet data for downlink transmission to user equipment, or
a bypass path that bypasses the L1-PHY downlink transcoder path and routes the first downlink packet data for downlink transmission to user equipment.

15. A device, comprising:
a Layer-1 physical interface (L1-PHY) transcoder device, the L1-PHY transcoder device comprising a downlink transcoder path, a downlink bypass path, an uplink transcoder path, and an uplink bypass path,
an edge compute device that:
performs data preprocessing on terrestrial uplink communication signals, obtained from a user equipment configured for cellular telecommunications, to be transmitted to a satellite via a metasurface, and
executes a trained selection model,
wherein the trained selection model is usable to select the uplink transcoder path to convert the terrestrial uplink communication signals from the user equipment, received by the L1-PHY transcoder device, to non-terrestrial uplink communication signals for uplink transmission to the satellite via the metasurface,
wherein the trained selection model is usable to select the uplink bypass path to route the terrestrial uplink communication signals from the user equipment as the non-terrestrial uplink communication signals for the uplink transmission to the satellite via the metasurface,
wherein the trained selection model is usable to select the downlink transcoder path to convert non-terrestrial downlink communication signals from the satellite, received by the L1-PHY transcoder device as redirected via the metasurface, to terrestrial downlink communication signals for downlink transmission to the user equipment, and
wherein the trained selection model is usable to select the downlink bypass path to route the non-terrestrial downlink communication signals from the satellite as the terrestrial downlink communication signals for the downlink transmission to the user equipment.

16. The device of claim 15, wherein the data preprocessing performs at least one of: data filtering on the terrestrial uplink communication signals, anomaly detection on the terrestrial uplink communication signals, predictive analytics on the terrestrial uplink communication signals, or data compression on the terrestrial uplink communication signals.

17. The device of claim 15, wherein the data preprocessing at least one of: filters redundant data from the terrestrial uplink communication signals, or performs bandwidth optimization corresponding to the uplink transmission of the terrestrial uplink communication signals.

18. The device of claim 15, wherein the edge compute device performs management and monitoring of at least one of: the L1-PHY transcoder device, or the trained selection model.

19. The device of claim 18, wherein the edge compute device performs prioritization of services, the services comprising the data preprocessing and the management and monitoring.

20. The device of claim 15, wherein the edge compute device is incorporated into a transcoder device structure that comprises the L1-PHY transcoder device, and wherein the transcoder device structure is one transcoder device structure of a group of transcoder device structures operating in parallel.
